(19) United States
(12) Patent Application Publication
(10) Pub. No.: US 2017/0331687 A1
(43) Pub. Date: Nov. 16, 2017

(54) OPTIMIZING THE TOPOLOGY OF A NETWORK WITH VARIABLE TRAFFIC DEMANDS

(71) Applicant: ARIA NETWORKS LIMITED, Bath (GB)

(72) Inventors: John CRICKETT, Chippenham, Wiltshire (GB); Jay PERRETT, Chippenham, Wiltshire (GB); Andrea CELLETTI, Chippenham, Wiltshire (GB)

(73) Assignee: ARIA NETWORKS LIMITED, Bath (GB)

(21) Appl. No.: 15/531,362

(22) PCT Filed: Nov. 27, 2015
(86) PCT No.: PCT/GB2015/053642

§ 371 Date: May 26, 2017

(30) Foreign Application Priority Data
Nov. 28, 2014 (GB) 1421184.1

(51) Int. Cl. H04L 12/24

(52) U.S. Cl. CPC H04L 41/0823; H04L 41/12; H04L 41/0816; H04L 41/0866

(57) ABSTRACT

Methods and systems for determining the topology of a network having variable traffic demands over a plurality of time periods. The method comprises generating a set of candidate network topologies from a set of network resources including a candidate network topology that satisfies each requirement for each service over the time periods. Each candidate network topology is then evaluated against one or more constraints for the set of service requirements for each time period. It is then determined if a stop condition is satisfied. If the stop condition is not satisfied then the set of candidate network topologies is evolved. If, however, the stop condition is satisfied then the best candidate network topology based on the evaluation is selected as the network topology.

### BACKGROUND

Networks may have different traffic patterns for different time periods. For example, a global network that spans multiple time zones may have different traffic patterns for different times of the day. In particular, when it is daytime in Sydney, Australia and nighttime in Toronto, Canada, for example, traffic to and from Sydney may be high, but traffic to and from Toronto may be low. Whereas when it is nighttime in Sydney and daytime in Toronto, traffic to and from Sydney may be low and traffic to and from Toronto may be high.

Designing a network to accommodate such differing traffic demands is quite challenging, particular for a large global network. It is important to design a network that has sufficient, but not excessive capacity to meet the varying demands. A typical solution to the problem has been to design the network with sufficient capacity to accommodate the worst-case demands. However, this produces a network with a significant amount of excess capacity, particular during non-peak times.

Accordingly there is a desire for a system and method for optimizing the topology of a network with different traffic patterns for different time periods.

The embodiments described below are not limited to implementations which solve any or all of the disadvantages of known network optimization systems.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Described herein are methods and systems for determining the topology of a network having variable traffic demands over a plurality of time periods. The method comprises generating a set of candidate network topologies from a set of network resources including a candidate network topology that satisfies each requirement for each service over the time periods. Each candidate network topology is then evaluated against one or more constraints for the set of service requirements for each time period. It is then determined if a stop condition is satisfied. If the stop condition is not satisfied then the set of candidate network topologies is evolved. If, however, the stop condition is satisfied then the best candidate network topology based on the evaluation is selected as the network topology.

A first aspect provides a system to generate a network to support a set of service requirements for each of a plurality of time periods, each set of service requirements specifying a requirement for each of a plurality of services, each requirement indicating an amount of data to be transmitted from a start node to an end node, the system comprising: a candidate generation module configured to: generate a set of candidate network topologies from a set of network resources, the set of candidate network topologies comprising a candidate network topology that satisfies each requirement for each service over the plurality of time periods; and repeatedly evolve the set of candidate network topologies; a candidate evaluation module configured to repeatedly evaluate each of the candidate network topologies to determine how well the candidate network topology meets the set of service requirements for the plurality of time periods and one or more user-specific technical constraints; a stop condition module configured to repeatedly determine if a stop condition is satisfied, and in response to determining the stop condition is satisfied select the best candidate network topology from the set of candidate network topologies based on the evaluation of the candidate network topologies and output the selected candidate network topology; and means for generating a network having the output network topology.

A second aspect provides a system to determine a topology for a network to support a set of service requirements for each of a plurality of time periods, each set of service requirements specifying a requirement for each of a plurality of services, each requirement indicating an amount of data to be transmitted from a start node to an end node, the system comprising: a candidate generation module configured to: generate a set of candidate network topologies from a set of network resources, the set of candidate network topologies comprising a candidate network topology that satisfies each requirement for each service over the plurality of time periods; and repeatedly evolve the set of candidate network topologies; a candidate evaluation module configured to repeatedly evaluate each of the candidate network topologies to determine how well the candidate network topology meets the set of service requirements for the plurality of time periods and one or more user-specific technical constraints; and a stop condition module configured to repeatedly determine if a stop condition is satisfied, and in response to determining the stop condition is satisfied select the best candidate network topology from the set of candidate network topologies based on the evaluation of the candidate network topologies and output the selected candidate network topology.

A third aspect provides a method to generate a network to support a set of service requirements for each of a plurality of time periods, each set of service requirements specifying a requirement for each of a plurality of services, each requirement indicating an amount of data to be transmitted from a start node to an end node, the method comprising: generating, using a computer, a set of candidate network topologies from a set of network resources, the set of candidate network topologies comprising a candidate network topology that satisfies each requirement for each service over the plurality of time periods; repeatedly evaluating, using the computer, each of the candidate network topologies to determine how well the candidate network topology meets the set of service requirements for the time periods and one or more constraints; repeatedly determining, using the computer, if a stop condition is satisfied; in response to determining the stop condition is not satisfied, evolving, using the computer, the set of candidate network topologies; and in response to determining the stop condition is satisfied, selecting, using the computer, the best candidate network topology from the set of candidate network topologies based on the evaluation of the candidate network topologies; outputting the selected candidate network topology; and generating a network having the output network topology.

A fourth aspect provides a computer-implemented method to determine a topology for a network to support a set of service requirements for each of a plurality of time periods, each set of service requirements specifying a requirement for each of a plurality of services, each requirement indicating an amount of data to be transmitted from a start node to an end node, the method comprising: generating a set of candidate network topologies, at a candidate generation module, from a set of network resources, the set of candidate network topologies comprising a candidate network topology that satisfies each requirement for each service over the plurality of time periods; repeatedly evaluating, at a candidate evaluation module, each of the candidate network topologies to determine how well the candidate network topology meets the set of service requirements for the time periods and one or more user-specified technical constraints; repeatedly determining, at a stop condition module, if a stop condition is satisfied; in response to determining the stop condition is not satisfied, evolving the set of candidate network topologies; in response to determining the stop condition is satisfied, selecting the best candidate network topology from the set of candidate network topologies based on the evaluation of the candidate network topologies; and outputting the selected candidate network topology.

A fifth aspect provides a computer readable storage medium having encoded thereon computer readable program code which when run by a computer causes the computer to perform the method of the fourth aspect.

The methods described herein may be performed by a computer configured with software in machine readable form stored on a tangible storage medium e.g. in the form of a computer program comprising computer readable program code for configuring a computer to perform the constituent portions of described methods or in the form of a computer program comprising computer program code means adapted to perform all the steps of any of the methods described herein when the program is run on a computer and where the computer program may be embodied on a computer readable storage medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

The hardware components described herein may be generated by a non-transitory computer readable storage medium having encoded thereon computer readable program code.

This acknowledges that firmware and software can be separately used and valuable. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 is a schematic diagram of an example global network;

FIG. 2 is a schematic diagram of an example demand matrix for multiple time periods;

FIG. 3 is a block diagram of an example system for optimizing the topology of a network with variable traffic demands;

FIG. 4 is a flow diagram of an example method of optimizing the topology of a network with variable traffic demands using the system of FIG. 3;

FIG. 5 is a schematic diagram illustrating generation of a set of candidate network topologies;

FIG. 6. is a flow diagram of an example method of generating a seed candidate network topology;

FIG. 7 is a schematic diagram illustrating generation of a seed candidate network topology using the method of FIG. 6;

FIG. 8 is a schematic diagram illustrating assigning capacity values to links of a candidate network topology;

FIG. 9 is a schematic diagram of an example set of constraints;

FIG. 10 is a flow diagram of an example method of evaluating a candidate network topology;

FIG. 11 is a schematic diagram illustrating generation of a fitness value for a candidate network topology;

FIG. 12 is a flow diagram of an example method for evolving the set of candidate network topologies;

FIG. 13 is a schematic diagram illustrating a method of generating child candidate network topologies through mating;

FIG. 14 is a schematic diagram illustrating a method of generating child candidate network topologies through mutation;

FIG. 15 is a chart illustrating an example stop condition; and

FIG. 16 is an example computing-based device.

Common reference numerals are used throughout the figures to indicate similar features.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

Described herein are methods and systems for identifying an optimum network topology for a network with demands that vary over different time periods.

The term “network” is used herein to mean any interconnection of elements for the transfer of data or information. A network may comprise a plurality of physical objects, such as a network of IP (Internet Protocol) routers, a telephone communications system, a utility distribution system or a network of blood vessels. Alternatively, a network may comprise a plurality of abstract objects, such as a data flow or social interactions.

The topology of a network defines the specific interconnections or links between the objects of the network. The network topology comprises a number of nodes and links that connect the nodes. Each node represents a terminal point or intersection point of a network. A node may be, for example, a topology element such as a location in a network; a system; a physical element such as a router, switch terminal, hub, branch, intersection or the like; or a virtual element such as a channel.

Each link provides a connection between two nodes. A link may be, for example, a physical element such as a cable, pipe or road; an abstract element such as a network link; or a virtual element such as a channel or frequency of a link or cable. Each link is typically associated with a capacity or bandwidth that defines the amount of data or information that can be transferred between the two nodes connected via the link.

As described above networks may have different traffic patterns for different time periods. For example, some networks may have different traffic patterns for different hours of the day, days of the month/year, weeks of the month, months of the year, quarters of the year etc. A time period will also be referred to herein as an epoch.

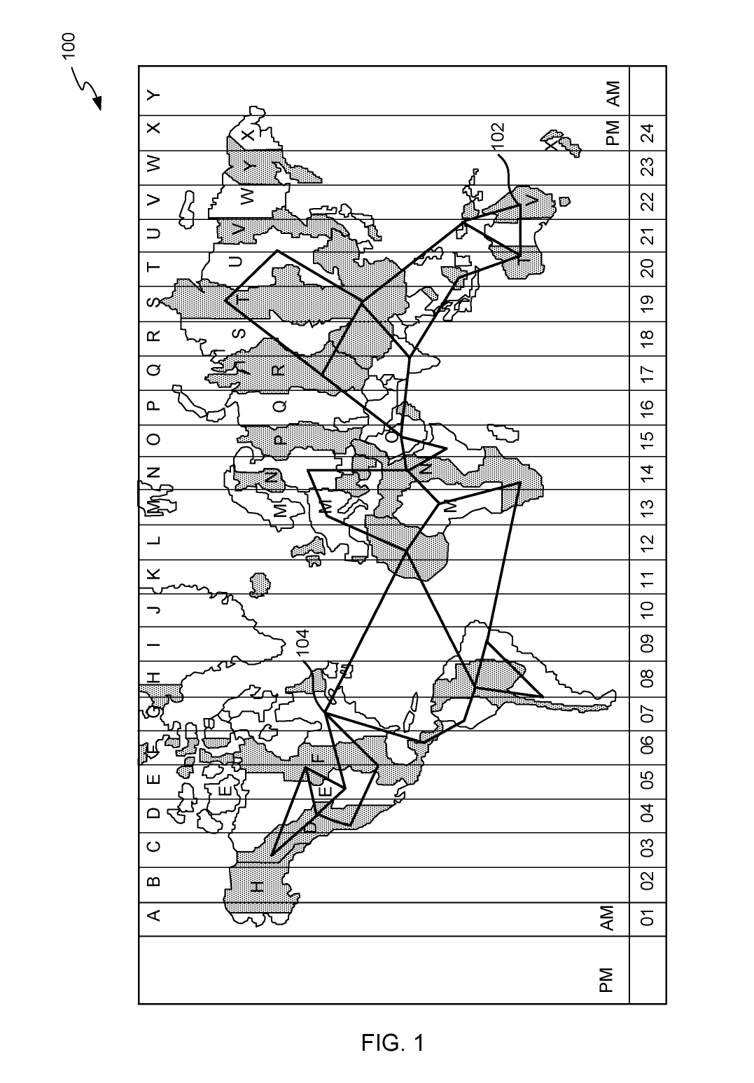

Reference is made to FIG. 1 which illustrates an example global network 100 that spans multiple time zones. The global network may have different traffic patterns (i.e. demands) for different times of the day. For example, when it is daytime in Sydney, Australia 102 and nighttime in Toronto, Canada 104, for example, traffic to and from Sydney 102 may be high, but traffic to and from Toronto 104 may be low. Whereas when it is nighttime in Sydney 102 and daytime in Toronto 104, traffic to and from Sydney 102 may be low and traffic to and from Toronto 104 may be high.

While in the example of FIG. 1 the different traffic patterns are a result of the network spanning different time zones, in other networks the different traffic patterns may be caused by one or more other factors. For example, a network for a financial institution may have higher demand on quarterly and monthly dates due to certain news releases, such as, but not limited to, unemployment and/or income figures.

It will be evident to a person of skill in the art that the principles and techniques described herein may be applied to any time periods with different traffic patterns regardless of the cause of the differing traffic patterns.

The traffic patterns are typically represented by a demand matrix which comprises the demand or requirement of each service that is run over the network. Each service represents traffic/information/data that is sent from one node (e.g. the start node or source node) in the network to another (e.g. the end node or destination node). The demand or requirement of a service is the amount of traffic/information/data routed or sent from the start node to the end node. The demand or requirement may be represented by a bandwidth or capacity value. Where a network has different demands for different time periods there may be a different demand matrix for each time period or epoch. Alternatively, there may be a single demand matrix that comprises demand information for each time period or epoch. In either case, a service may have no demand or zero demand in one or more epochs. For example, there may be no traffic generated from Toronto when it is in the middle of the night in Toronto.

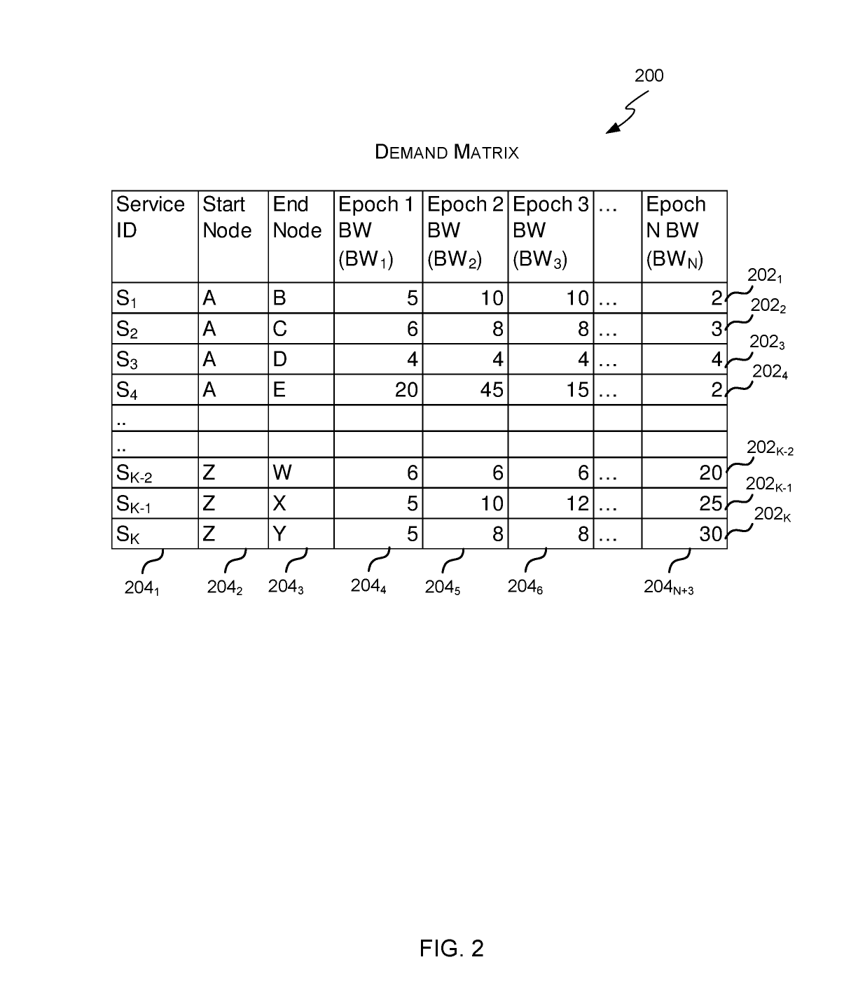

An example demand matrix 200 is illustrated in FIG. 2. The demand matrix 200 of FIG. 2 comprises a number of rows 202₁-202_{K} and columns 204₁-204_{N+3}.

Each row 202₁-202_{K} corresponds to a service that runs over the network. Accordingly, where there are K services there are K rows in the demand matrix 200.

Each column 204₁-204_{N+3} provides information on the corresponding service. In the demand matrix 200 of FIG. 2, the first column 204₁ is used for the service identifier (e.g. S₁) which uniquely identifies the service. The second column 204₂ is used to identify the start node of the service, and the third column 204₃ is used to identify the end node of the service. In some cases the nodes may be assigned a unique identifier which is used to identify the start and end nodes in the demand matrix 200. In the example shown in FIG. 2 each node is assigned a letter, but it will be evident to a person of skill in the art that this is an example only and other forms of unique identifiers may be used.

The remaining columns 204₄-204_{N+3} are each used to identify the demand or requirement for the service (e.g. the amount of traffic that is sent from the specified source node to the specified destination node) for a particular time period or epoch. Accordingly there is a requirement column for each time period or epoch to be analyzed. Each requirement may be represented by a capacity or bandwidth value (e.g. 10 Gbps).

It will be evident to a person of skill in the art that the demand matrix 200 of FIG. 2 is an example only and the demand matrix may comprise additional or alterative information; or the services and the requirements thereof may be represented in a different manner. For example, the demand matrix may also include routing rules/constraints that describe how a particular service is to be routed through the network.

Designing a network topology to accommodate variable traffic demands is quite challenging, particular for a large global network due to the large number of nodes in such a network. It is important to design a network that has sufficient, but not excessive capacity to meet the varying demands. A typical solution to the problem has been to design the network with sufficient capacity to accommodate the worst-case demands whilst only reaching a low maximum utilization (e.g. 60%). However, this produces a network with a significant amount of excess capacity (which is often quite expensive), particular during non-peak times.

To address this issue, described herein are systems and methods for identifying a network topology that is optimized for a plurality of time dependent traffic patterns based on one or more constraints. In some cases the methods and systems described herein comprise identifying an optimum network topology using an iterative process. The iterative process comprises generating a set of candidate network topologies from a set of network resources; evaluating each of the candidate network topologies against each of the traffic patterns; determining if a stopping condition has been met, and in response to determining a stopping condition has not been met evolving the set of candidate network topologies based on the evaluation and then repeating.

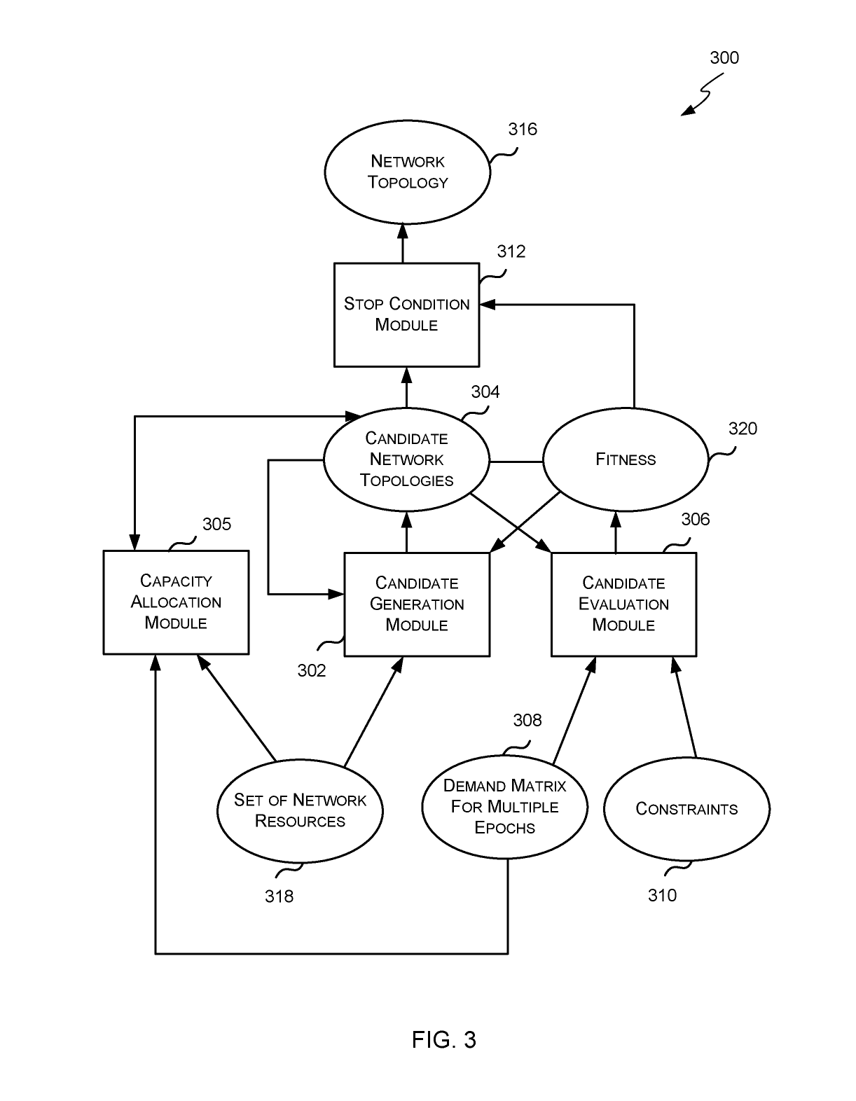

Reference is now made to FIG. 3 which illustrates an example system 300 for identifying an optimum network topology for a set of traffic patterns based on one or more constraints. The system 300 uses an iterative process to refine and evaluate candidate network topologies to identify the optimum network topology for the set of traffic patterns based on the specified constraint(s).

The system 300 comprises a candidate generation module 302 for generating and iteratively evolving a set of candidate network topologies 304; a capacity allocation module 305 for assigning capacity values to the links of the candidate network topologies 304; a candidate evaluation module 306 for evaluating the candidate network topologies 304 to determine how well they meet the set of traffic patterns set out in the demand matrix 308 and one or more constraints 310; and a stop condition module 312 for determining, based on the evaluation of the candidate network topologies, when the iterative process can be stopped and then selecting the best candidate network topology as the optimum network topology 316.

The candidate generation module 302 receives a set of network resources 318 and generates a set of candidate network topologies 304.

The set of network resources 318 comprises all of the components that may form the network and the possible configurations thereof. For example, the set of network resources 318 may comprise all of the possible nodes in the network, all of the potential links in the network, all of the possible capacity options for each link in the network, and/or all of the possible hardware components that can be used to form the network. This set of network resources may be generated by the user based on the options available to them to create their network. For example, the nodes may represent datacenters and the links between them may be the full list of options they have for linking two (or more) datacenters together. Such options could include, microwave links, satellite links, laying their own fiber, renting fiber, or renting capacity on a third party's fiber/microwave/satellite links.

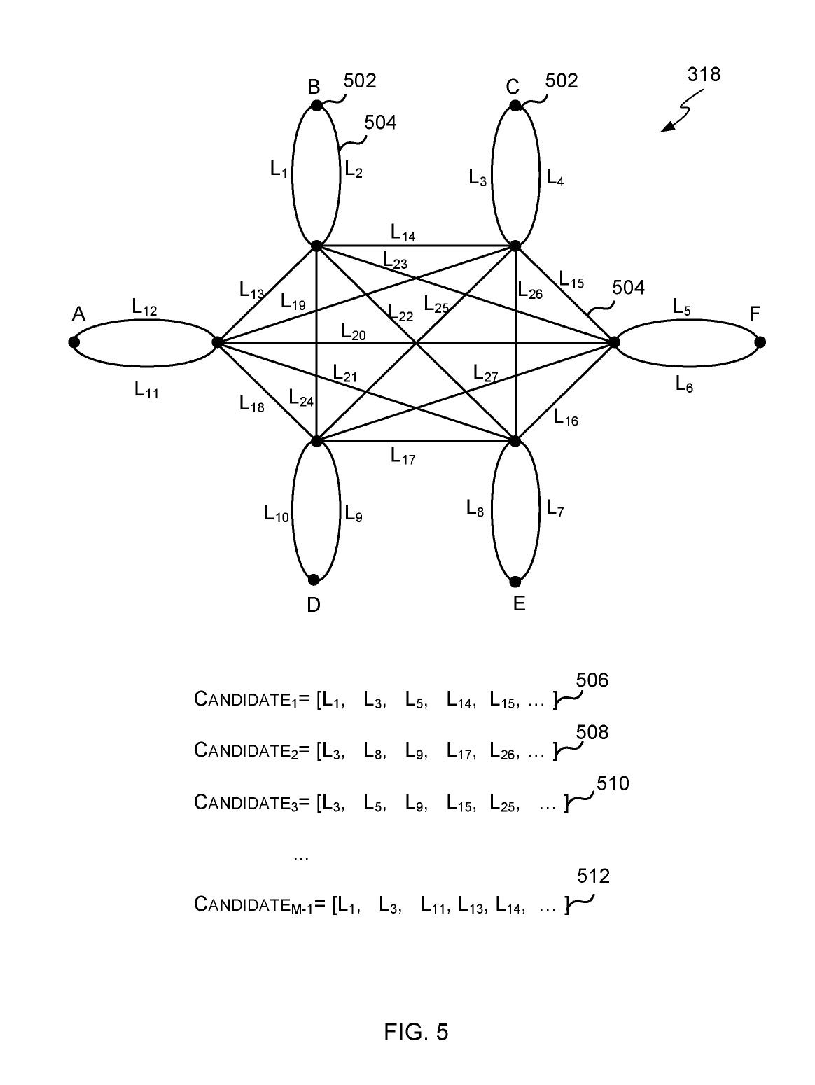

The candidate generation module 302 takes the set of network resources 318 and generates an initial set of candidate network topologies 304. Each candidate network topology comprises a set of nodes and links from the set of network resources 318 that form a network topology. In some cases the candidate network topologies may be represented by a vector that comprises a list of the links forming the topology. Example candidate network topologies are described with reference to FIG. 5.

In some cases the candidate generation module 302 is configured to initially generate a predetermined number M, in one example 50, candidate network topologies 304.

In some cases the candidate generation module 302 is configured to randomly generate M−1 candidate network topologies and to generate one seed candidate network topology. Randomly generating a candidate network topology may comprise randomly selecting a subset of the links in the set of resources.

The seed candidate network topology is designed to bring the set of candidate network topologies 304 closer to the optimum network topology sooner. More particularly, the seed candidate network topology is used to guide the evolution of the candidate network topologies, thus improving the performance (in terms of computational expense and time) of this highly complex optimization problem.

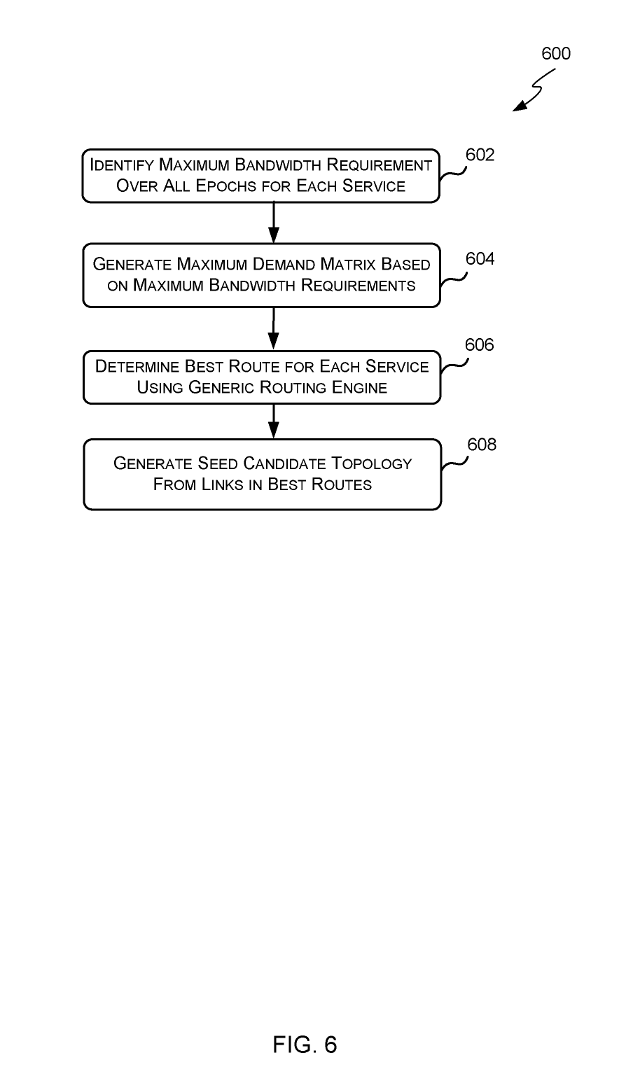

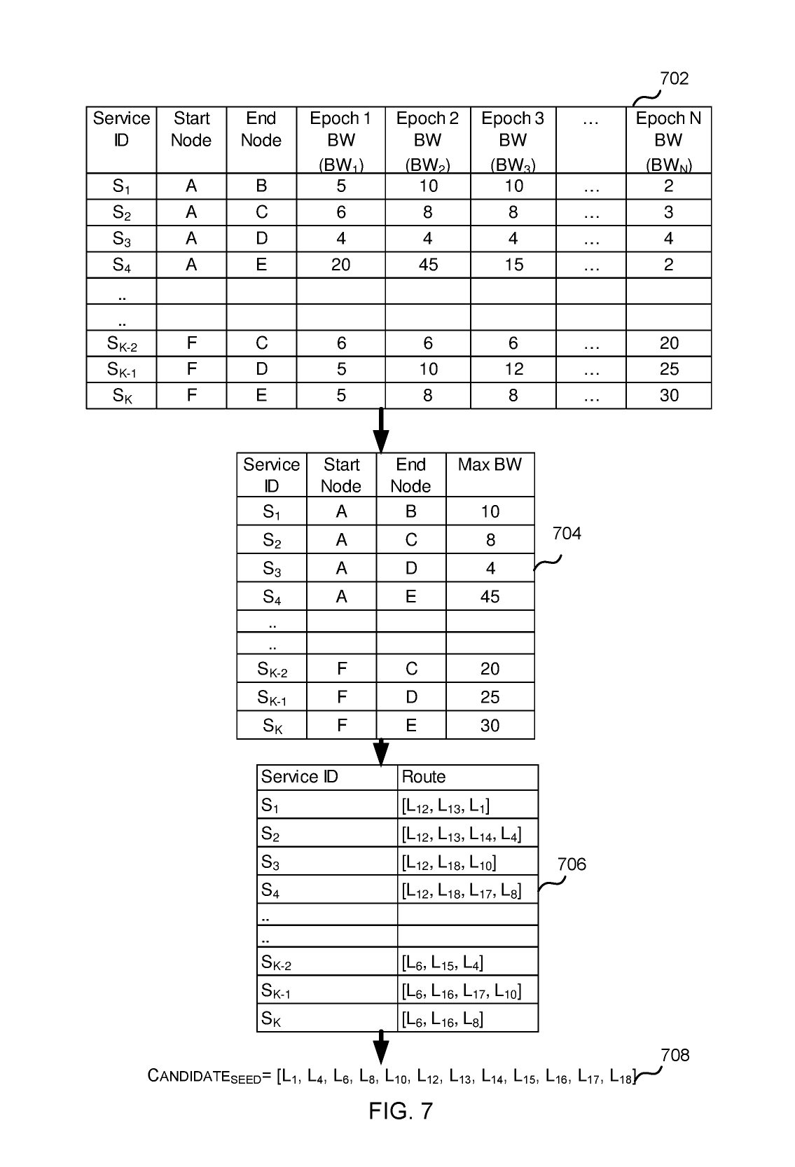

In some cases the seed network topology is a network topology designed to satisfy the worst case (e.g. maximum) demand for each service over all of time periods in the demand matrix 308. Generating the seed network topology may involve an iterative process that comprises generating a set of candidate network topologies, evaluating the candidate network topologies to determine how well they satisfy the worst case (e.g. maximum) demands and evolving the set of candidate network topologies until a stop condition has been met. An example method for generating the seed candidate network topology is described with reference to FIGS. 6 and 7.

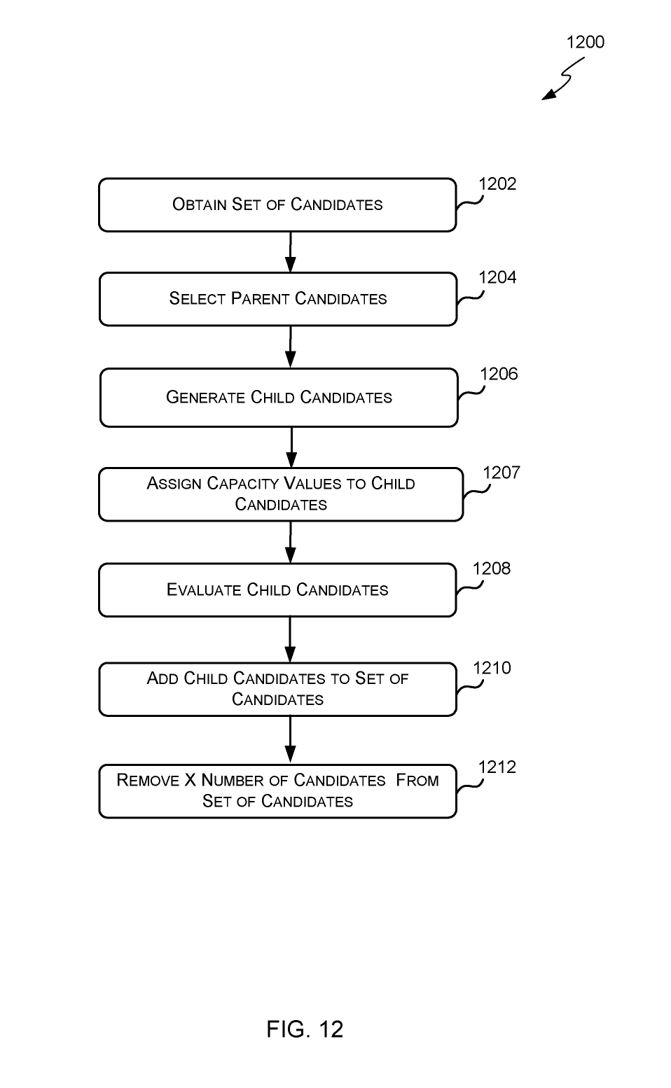

The candidate generation module 302 is also configured to periodically update or evolve the set of candidate network topologies 304 by selecting one or more candidate network topologies from the set of candidate network topologies 304, forming new candidate network topologies from the selected candidate network topologies (e.g. via mutation, mating (e.g. crossover), and/or a combination thereof), and replacing some of the candidate network topologies in the set with the new candidate network topologies. In some cases the new candidate network topologies replace the poorest candidate network topologies in the set if they are better. In other cases, the candidate network topologies that are replaced by the new candidate network topologies may be selected using other criteria. For example, the candidate network topologies that are replaced by the new candidate network topologies may be randomly selected from the set of candidate network topologies. An example method for updating or evolving the set of candidate network topologies 304 that may be executed by the candidate generation module 302 is described with reference to FIGS. 12-14.

The capacity allocation module 305 assigns a capacity value (e.g. bandwidth value) to each link of the candidate network topologies 304. In some cases assigning capacity values to the links of a candidate network topology comprises determining the route for each service through the candidate network topology.

The route for a service comprises a set of links that the traffic traverses to get from the start node to the end node. The route for each service may be determined by a generic routing engine (GRE) through an iterative process. The iterative process may comprise generating a set of candidate service routings, evaluating the candidate service routings to determine how well they satisfy the routing constraints specified in the demand matrix and/or requirements for each service and evolving the set of candidate service routings until a stop condition has been met. Alternatively, the services may be routed using a known routing protocol such a Border Gateway Protocol (BGP), Internet Protocol (IP), IP with equal-cost multi-path (ECMP), least cost, or constrained shortest path first (CSPF).

Once the routing of the service has been determined the utilization of each link for each time period is then determined based on the requirements in the demand matrix 308. A capacity value (e.g. bandwidth value) is then assigned to each link to satisfy the maximum utilization over the time periods or epochs. For example, if the utilization of a link is 10 Gbps for one epoch and 25 Gbps for another epoch, a capacity value of at least of 25 Gbps is assigned to the link.

In some cases the capacity allocation module 305 may also take into account maximum utilization values that have been assigned to one or more of the links when assigning capacity (e.g. bandwidth) values. For example, if a particular link has been assigned a maximum utilization of 33.3% then a maximum utilization of 10 Gbps results in a capacity value of at least 30 Gbps being assigned to the link.

In some cases the routing of services is determined for the candidate network topology in steady-state (e.g. all nodes and links are active). In other cases the routing of services is also determined for the candidate network topology in one or more a failure states (i.e. under one or more failure conditions). A failure condition may be one or more network failures, such as failure of a link, node, shared risk group etc., during which services unaffected by the failure are not re-routed and services affected by the failure are only re-routed if they are protected.

In cases where the routing of services is determined for the candidate network topology in steady state and in one or more failure states a capacity (e.g. bandwidth) value is assigned to each link to satisfy the maximum utilization of that link over all epochs in both steady state and the one one or more failure states. For example, if the maximum utilization of link is 10 Gbps in steady state, and 25 Gbps in a failure state then a capacity (e.g. bandwidth) value of at least 25 Gbps is assigned to the link.

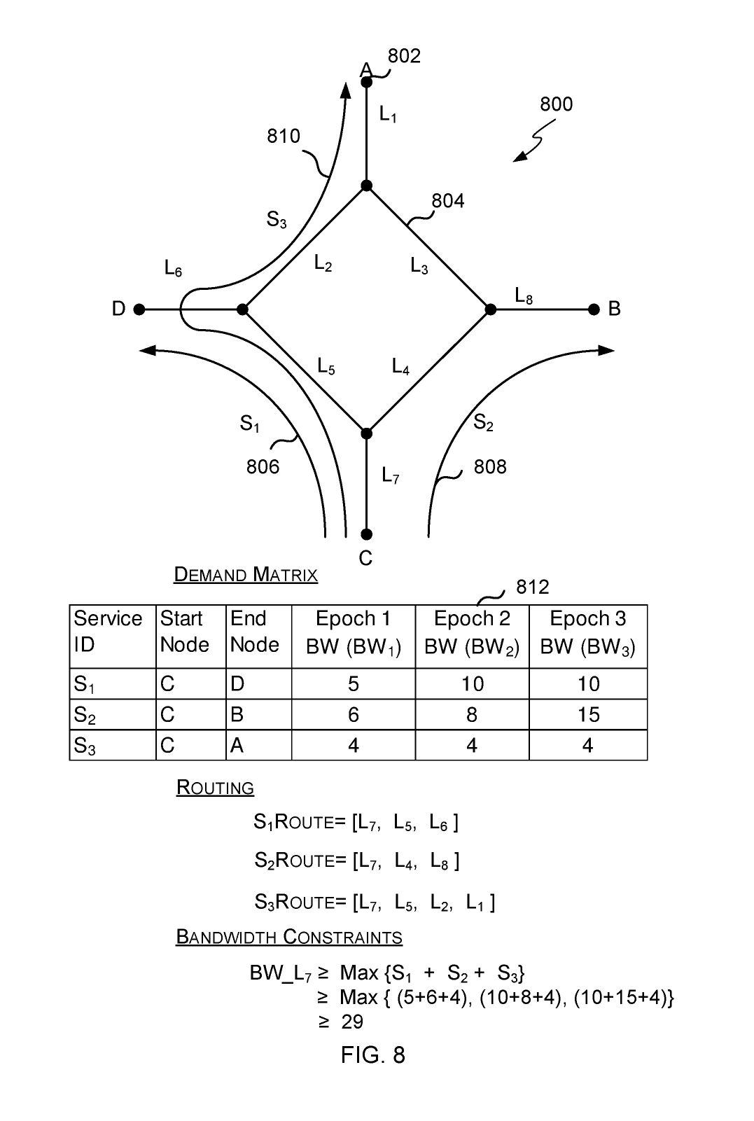

An example of assigning capacity values to links of a candidate network topology is described with reference to FIG. 8.

The candidate evaluation module 306 evaluates each of the candidate network topologies (including the service routing and capacity values identified by the capacity allocation module 305) 304 based on how well the candidate network topology satisfies the traffic patterns specified in the demand matrix 308 and the one or more specified constraints 310.

The set of constraints 310 includes one or more features (referred to as a constraint) that the candidate network topologies are evaluated against. The set of constraints may be determined by the user, based on the way in which they wish to optimize their network topology. For example, one user may wish to generate the cheapest (in monetary terms) network that can support their demands; another user may wish to generate the topology that provides the lowest latency regardless of the monetary cost; and yet another user may wish to achieve the best latency for a given cost.

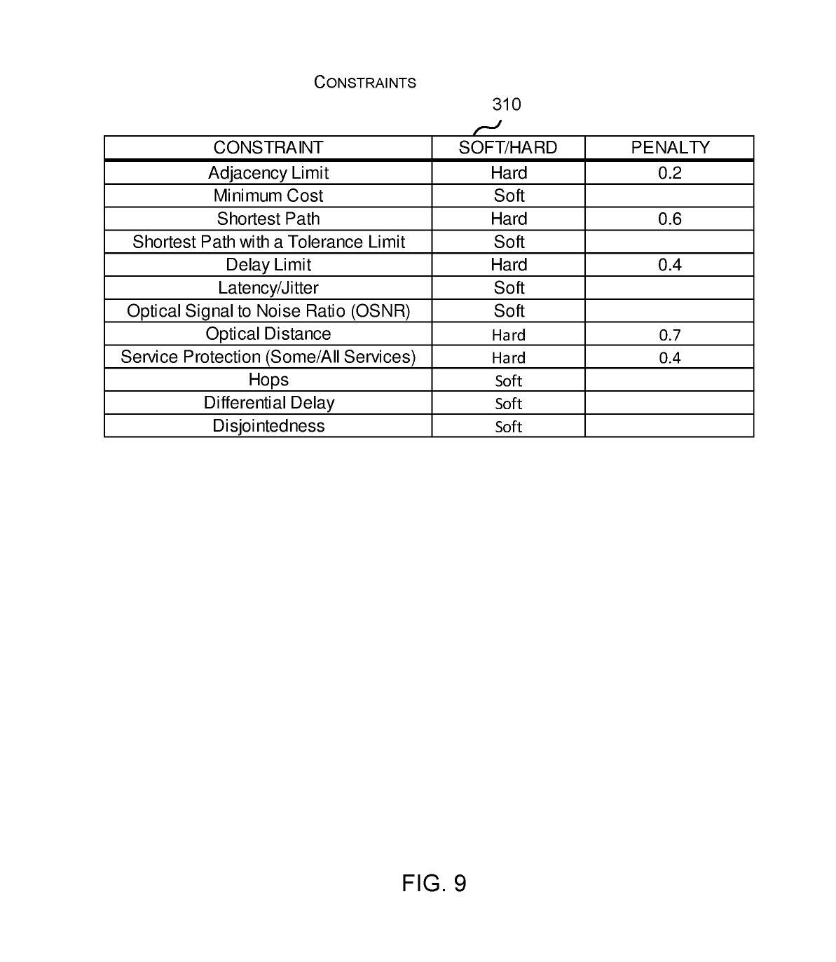

The constraints may be classified as being either hard constraints or soft constraints. A hard constraint must be satisfied for the candidate network topology to be a viable network topology. Accordingly the candidate evaluation module 306 will not consider a candidate network topology that does not satisfy a hard constraint as meeting the constraint(s) very well. Example hard constraints include, but are not limited to, minimum bandwidth, maximum delay, and adjacency limit. In contrast, a soft constraint is preferred and ideally should be optimized, but is not required. Example soft constraints include, but are not limited to, minimize cost and minimize delay. Example constraints will be described in more detail with reference to FIG. 9.

Not all constraints may be of equal importance, so in some cases the set of constraints 310 may comprise, in addition to a listing of the constraints themselves, weights indicating the relative importance of the constraints.

As described above, the demand matrix 308 provides a list of services to be routed through the network and the requirements of the service for each of a plurality of time periods. The time periods may be any increment of time such as, but not limited to, a minute, minutes, hour, hours, day, days, week, weeks, month, months, year or years.

As described above, a service represents traffic/information/data that is sent from one node in a network (e.g. the start or source node) to another (e.g. the end or destination node). The requirement of a service is the amount of traffic/information/data sent from the start node to the end node. An example demand matrix 200 was described with reference to FIG. 2.

In some cases the candidate evaluation module 306 is configured to generate a fitness value 320 for each candidate network topology (including the routing of services and capacity values identified by the capacity allocation module 305) based on the traffic/data/information patterns specified in the demand matrix 308 and the set of constraints 310. The fitness value 320 provides a quantitative measure of how well the candidate network topology satisfies the traffic patterns specified in the demand matrix 308 and the constraints 310. In some cases, the higher the fitness value the better the candidate, and the lower the fitness value the poorer the candidate. In some cases the fitness value is a number between 0 and 1 where 1 indicates an optimum candidate and 0 indicates a very poor candidate.

The fitness value for a candidate network topology (including the service routing and capacity values identified by the capacity allocation module 305) is computed by calculating a fitness value for that candidate network topology for each time period or epoch and then combining the fitness values for each time period or epoch (e.g. summing or averaging). For example, where there are 24 time periods, one for each hour of the day, then twenty-four fitness values are calculated, one for each one hour time period.

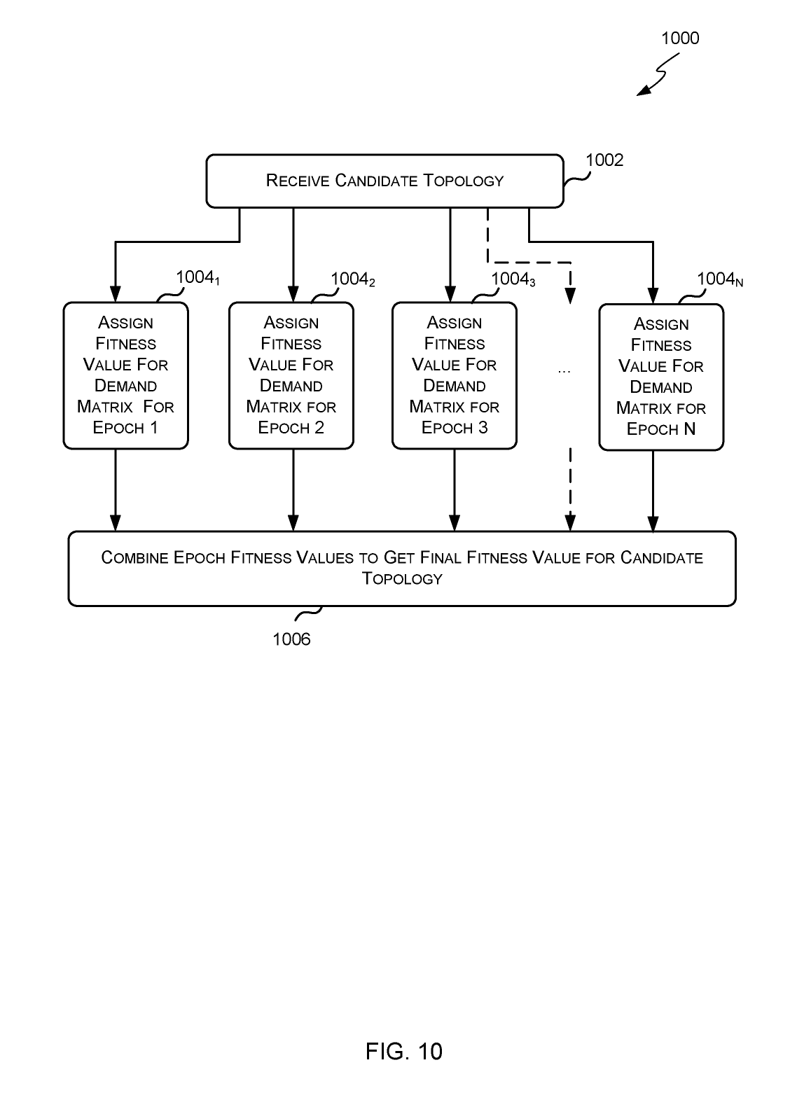

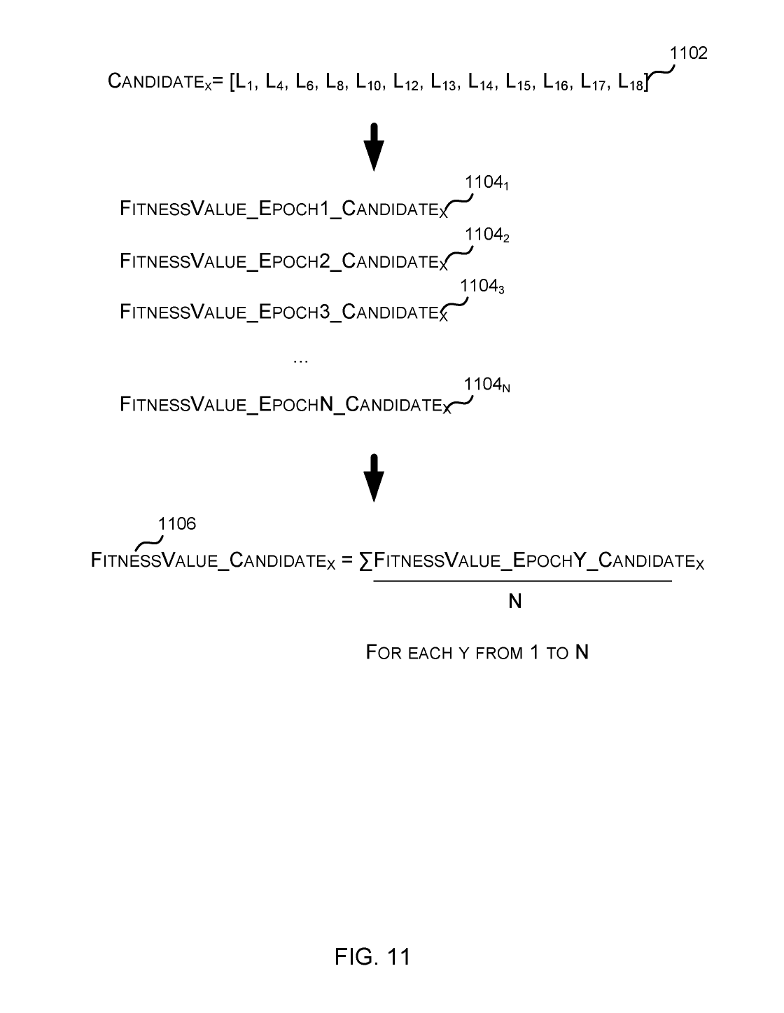

The fitness value for a particular time period or epoch for a particular candidate network topology may be computed by calculating a sub-fitness value for each constraint; and combining the sub-fitness values (e.g. summing or averaging). In some cases the constraints are not of equal importance so the fitness value may take into account the relative importance of the constraints. For example, the fitness value may be a weighted sum or a weighted average of sub-fitness values where the weight used for each sub-fitness value indicates the relative importance of the corresponding constraint. An example method for generating a fitness value for a candidate network topology is described with reference to FIGS. 10 and 11.

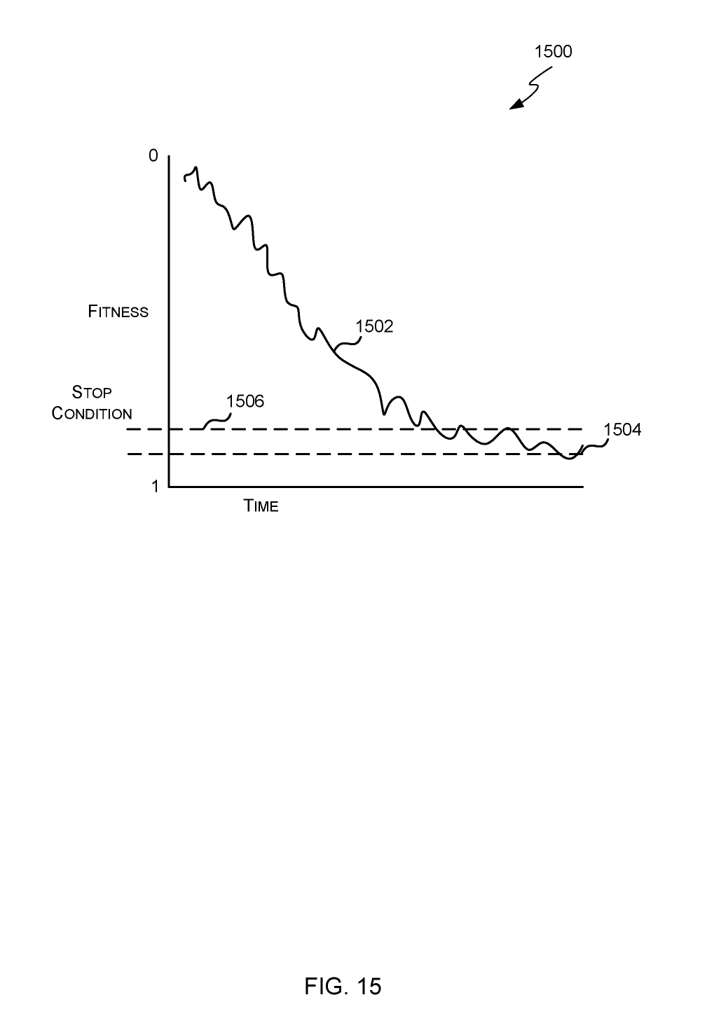

The stop condition module 312 determines when the iterative process of evaluating and updating/evolving the candidate network topologies 304 can end. In particular, the stop condition module 312 determines that the iterative process can stop if at least one stop condition has been met. One or more stop conditions may indicate that a sufficiently optimum network topology has been identified For example, the stop conditions may comprise one or more of: if the best fitness value in the set of fitness values 320 is within a predetermined percentage, x, of the predicted optimum fitness value; if the best fitness value in the set of fitness values 320 has not improved or changed after a predetermined number, y, of iterations; or if the best fitness value has a percentage likelihood of being the optimum fitness value over a predetermined threshold. An example stop condition will be described with reference to FIG. 15.

If the stop condition module 312 determines that at least one stop condition is met then the stop condition module 312 selects the candidate network topology or topologies that has/have the best fitness value and outputs the selected candidate network topology/topologies as the optimum network topology 316.

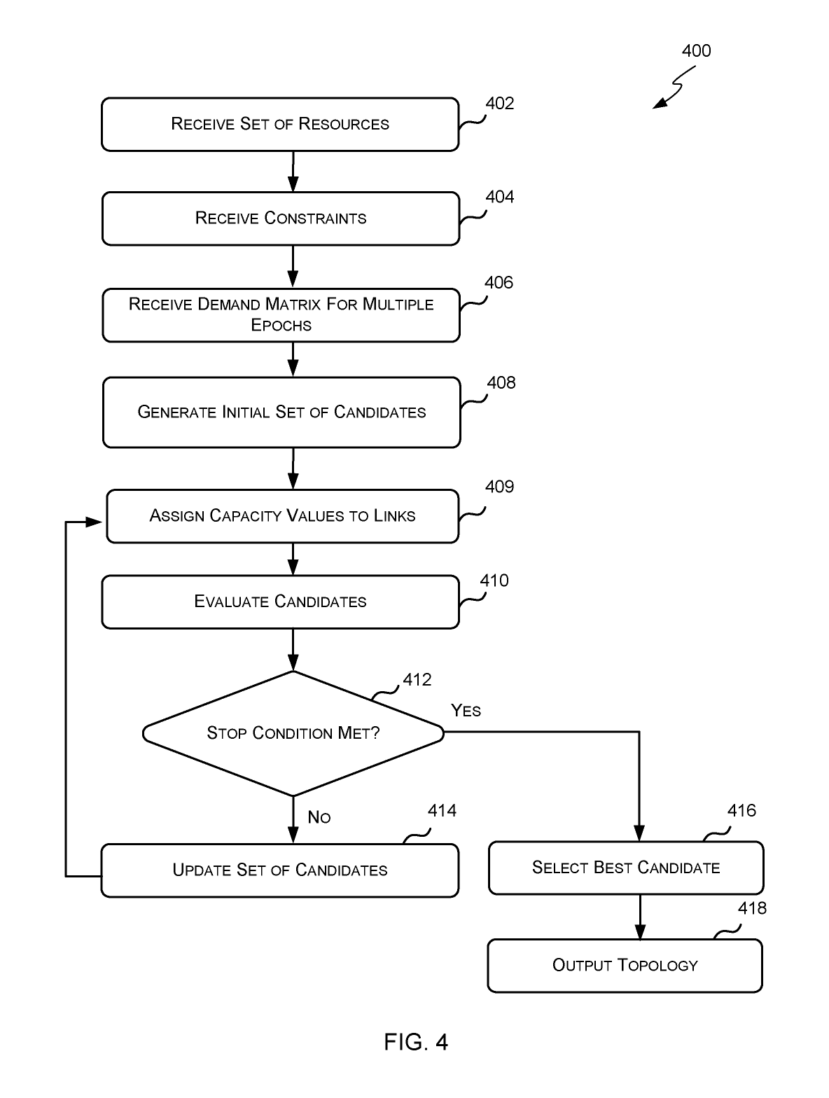

Reference is now made to FIG. 4 which illustrates a method 400 for identifying an optimum network topology to satisfy a set of traffic patterns for multiple time periods under one or more constraints using the system 300 of FIG. 3. The method 400 identifies an optimum network topology through an iterative process that generates a set of candidate network topologies, evaluates the candidate network topologies, and evolves or updates the set of candidate network topologies to create a set of stronger candidate network topologies. Since the quality of the candidate network topologies increases with each iteration, each iteration increases the probability that the set of candidate network topologies comprises the optimum network topology.

The method 400 begins at block 402 where the candidate generation module 302 receives the set of network resources 318. As described above, the set of network resources 318 comprises all of the potential components of the network and the possible configurations thereof which can be used to build the network topology. For example, the set of network resources 318 may comprise all of the possible nodes in the network, all of the potential links in the network, all of the possible capacity options for each link in the network, all of the possible hardware components that can be used to form the network etc. Once the set of network resources 318 have been received the method 400 proceeds to block 404.

At block 404, the candidate evaluation module 306 receives the set of constraints 310. As described above, the set of constraints 310 specify the features of the network topology that are used to evaluate the quality of a candidate network topology. The set of constraints may comprise one or more hard constraints which must be met for a candidate network topology to be viable and/or one or more soft constraints which are to be optimized, but are not required. The constraints may not be of equal importance and thus each constraint may be associated with a weight value that indicates its relative importance with respect to the other constraints. Once the set of constraints 310 have been received the method 400 proceeds to block 406.

At block 406, the candidate evaluation module 306 receives the demand matrix 308. As described above, the demand matrix 308 provides a list of services to be routed through the network and the requirement of each service for multiple time periods or epochs. As described above, a service represents traffic/information/data that is sent from one node (e.g. the start or source node) in a network to another (e.g. the end or destination node). The requirement of a service is the amount of traffic/information/data that is sent from the start node to the end node. As described above the demand matrix 308 may also include routing rules/constraints that describe how a particular service is to be routed through the network. Once the demand matrix 308 has been received the method 400 proceeds to block 408.

It will be evident to a person of skill in the art that blocks 402 to 406 may be executed in any order or in parallel. For example, the system 300 may concurrently receive the set of network resources 318, the demand matrix 308 and the set of constraints 310.

At block 408, the candidate generation module 302 generates an initial set of M (e.g. 50) candidate network topologies 304 from the set of network resources 318. Each candidate network topology comprises a subset of the nodes and links of the set of network resources 318. In some cases each candidate network topology is represented by a vector of links. The term “vector” is used herein to mean an ordered or unordered list of elements. An example set of candidate network topologies is described with reference to FIG. 5.

In some cases, M−1 of the candidate network topologies are randomly generated and one candidate network topology is generated as a seed candidate topology. Randomly generating a candidate network topology may comprise randomly selecting some or all of the links in the set of network resources 318.

The seed candidate network topology is designed to bring the set of candidate network topologies to the optimum network topology faster. More particularly, the seed candidate network topology is used to guide the evolution of the candidate network topologies, thus improving the performance (in terms of computational expense and time) of this highly complex optimization problem. In some cases the seed candidate network topology is generated to satisfy the maximum requirement for each service for all of the time periods or epochs. Accordingly, in some cases determining the seed candidate network topology comprises (i) determining the maximum requirement for each service from the demand matrix 308; (ii) determining the best route for each service for the maximum requirements; and (iii) generating a seed candidate network topology that comprises all the links that are part of at least one best route. An example method for generating the seed candidate network topology is described with reference to FIGS. 6 and 7.

Once the initial set of candidate network topologies has been generated the method 400 proceeds to block 409.

At block 409, the capacity allocation module 305 assigns a capacity (e.g. bandwidth) value to each link of the candidate network topologies 304. As described above with reference to FIG. 3, assigning capacity (e.g. bandwidth) values to the links of a candidate network topology may comprise determining the best route for each service through the candidate network topology.

The best route for a service comprises a set of links that the traffic traverses to get from the start node to the end node. The best route for each service may be determined by a generic routing engine (GRE) through an iterative process. The iterative process may comprise generating a set of candidate service routings; evaluating the candidate service routings to determine how well they satisfy the routing constraints specified in the demand matrix 308 and/or requirements for each service; and evolving the set of candidate service routings until a stop condition has been met. Alternatively, the routing of the services may be determined using a known routing protocol such a Border Gateway Protocol (BGP), Internet Protocol (IP), IP with equal-cost multi-path (ECMP), least cost, or constrained shortest path first (CSPF).

Once the routing of the services through the candidate network topology has been determined the utilization of each link for each time period or epoch is then determined from the requirements in the demand matrix 308. A capacity (e.g. bandwidth) value is then assigned to each link to satisfy the maximum utilization of the link over all time periods or epochs. For example, if the utilization of a link is 10 Gbps for one epoch and 25 GBps for another epoch, a capacity (e.g. bandwidth) of at least 25 Gbps is assigned to the link.

The actual capacity (e.g. bandwidth) value assigned may be based on the information in the set of network resources 318. In particular, the set of network resources 318 may specify the incremental increases in capacity that can be made for any particular link. For example, the set of network resources 318 may specify that a particular link may only be increased by 10 Gbps or 100 Gbps increments. The set of network resources 318 may also specify a maximum utilization value for one or more of the links. For example, if a particular link is assigned a maximum utilization of 33.33% then a calculated utilization of 10 Gbps results in a capacity value of at least 30 Gbps being assigned to the link.

In some cases the routing of services is determined for the candidate network topology in steady-state (e.g. all nodes and links are active). In other cases the routing of services is determined for the candidate network topology in steady state and in one or more failure states (i.e. under one or more failure conditions). A failure condition may be one or more network failures, such as failure of a link, node, shared risk group etc., during which services unaffected by the failure are not re-routed and services affected by the failure are only re-routed if they are protected.

Where the routing of services is determined for both steady state and one or more failure states the minimum capacity value assigned to a link is based on the maximum utilization of the link in steady state and one or more failure states. For example, if the maximum utilization of a link in steady state over all epochs is 20 Gbps and the maximum utilization of the link in a failure state over all epochs is 35 Gbps then the capacity value assigned to the link is at least 35 Gbps.

Once capacity (e.g. bandwidth) values have been assigned to each link of the candidate network topologies, the method 400 proceeds to block 410.

At block 410, the candidate evaluation module 306 evaluates each candidate network topology (including the service routing and capacity values identified in block 409) 304 against the set of constraints 310 and traffic patterns (requirements) for multiple time periods specified by the demand matrix 308. In some cases evaluation of a candidate network topology comprises assigning the candidate network topology a fitness value 320 that is a quantitative measure of how well the candidate network topology (i) meets the requirements for multiple time periods as defined in the demand matrix 308; and (ii) the constraint(s) 310.

As described above, in some cases generating a fitness value for a candidate network topology may comprise determining a fitness value for the candidate network topology for each time period or epoch to be evaluated and combining (e.g. summing or averaging) the fitness value for each time period or epoch. The fitness value for a particular epoch may be generating by generating a sub-fitness value for each constraint where each sub-fitness value is a quantitative measure of how well the candidate network topology meets the particular constraint; and combining (e.g. summing or averaging) the sub-fitness values to generate the fitness value.

Not all of the constraints may be of equal importance therefore in some cases the constraints may each assigned a weight that indicates their relative important. The fitness value for a particular epoch is then generated by a weight sum or weighted average of the sub-fitness values (the fitness values for each constraint). Preferably the fitness value is primarily driven by the network costs and penalties applied for failing to route services or breaching a hard constraint. An example method for evaluating a candidate network topology is described with reference to FIGS. 10-11.

The candidate network topologies may be evaluated (e.g. assigned a fitness value) serially or in parallel. For example, in some cases the candidate network topologies are evaluated in parallel.

Once the set of candidate network topologies 304 have been evaluated, the method 400 proceeds to block 412.

At block 412 the stop condition module 312 determines whether at least one stop condition has been met and the iterative process can stop. The stop condition(s) may be, for example, if the best fitness value in the set of fitness values 320 is within a predetermined percentage, x, of the predicted optimum fitness value; if the best fitness value in the set of fitness values has not improved or changed after a predetermined number, y, of iterations; and/or the likelihood that the best fitness value in the set of fitness values is above a predetermined threshold. It will be evident to a person of skill in the art that these are examples only and other stop conditions may be used.

If the stop condition module 312 determines that none of the stop conditions have been met then the method 400 proceeds to block 414. If, however, the stop condition module 312 determines that at least one stop condition has been met then the method proceeds to block 416.

At block 414, the candidate generation module 302 updates or evolves the set of candidate network topologies in an attempt to increase the quality of the candidate network topologies in the set. In particular, it is very unlikely that the initial set of candidate network topologies comprises the optimum network topology therefore the set of candidates is evolved to pull the candidate network topologies closer to the optimum network topology.

In some cases evolving the set of candidate network topologies comprises selecting one or more of the candidate network topologies, generating one or more new candidate network topologies from the selected candidate network topologies, and replacing some of the candidate network topologies in the set with the new candidate network topologies. In some cases the new candidate network topologies only replace candidate network topologies in the set if the new candidate network topologies are better (e.g. based on a fitness value) than candidate network topologies in the set.

For example, in some cases the candidate generation module 302 is configured to select a plurality of parent candidate network topologies from the set of candidate network topologies. The parent candidate network topologies may be the candidates with the best fitness values or the parent candidate network topologies may be selected using other criteria (e.g. they may be randomly selected). The candidate generation module 302 then generates one or more child candidate network topologies from the parent candidate network topologies using known techniques such as mating, mutation or a combination thereof and adds the child candidate network topologies to the set of candidate network topologies.

The method then proceeds back to blocks 409 and 410 where the capacity allocation module 305 allocates capacity values to the links of the child candidate network topologies and the candidate evaluation module 306 evaluates (e.g. assigns a fitness value to) each of the child candidate network topologies. The set of candidate network topologies is then reduced to M candidate network topologies where M is the number of candidate network topologies initially generated in block 408. In some cases the best M candidate network topologies (e.g. based on fitness value) are selected. In other cases M candidate network topologies are randomly selected. This process of evolving the set of candidate network topologies is repeated until a stop condition is satisfied. An example method for updating or evolving the set of candidate network topologies is described with reference to FIGS. 12 to 14.

At block 416, once a stop condition has been met, the stop condition module 312 selects the best candidate network topology (e.g. the candidate network topology with the best fitness value). Once the best candidate network topology has been selected the method 400 proceeds to block 418.

At block 418 the selected/best candidate network topology and the capacity (e.g. bandwidth) values assigned thereto are output as the optimum network topology for the traffic patterns specified in the demand matrix and the constraint(s) specified.

Reference is now made to FIG. 5 which illustrates an example method for generating candidate network topologies based on a set of network resources. In particular FIG. 5 shows an example of the nodes 502 and links 504 that form a set of network resources 318. Each link 504 is assigned a label or identifier (L₁ . . . L₂₇) which uniquely identifies the link—e.g. identifies which two nodes it connects.

A candidate network topology is any combination of the links 504 in the set of network resources 318. Accordingly, a candidate network topology may comprise all or a subset of the links 504 in the set of the network resources 318. The combination of links may be represented by an array or vector. In one example, as shown in FIG. 5, the array or vector may comprise a list of link identifiers. In this example, the order of the links is not relevant since it is the identifier that identifies the link. In another example, the array or vector may comprise a bit for each possible link and when that link has been selected as part of the candidate network topology the bit is set, otherwise the bit is cleared. In this example, the order of the information in the array or vector is relevant as certain bits map back to certain links.

Accordingly, the candidate generation module 302 may be configured to generate the initial set of M−1 random candidate network topologies 506, 508, 510, 512 by randomly selecting a number of links of the set of possible links and saving the selected link identifiers in an array or vector. The candidate network topologies do not have to have the same number of links and in fact they are likely to have different numbers of links. For example, FIG. 5 illustrates several candidate network topologies 506, 508, 510, 512 that may be generated from the set of network resources 318 illustrated in FIG. 5. The first example candidate network topology 506 comprises links L₁, L₃, L₅, L₁₄ and L₁₅; the second example candidate network topology 508 comprises links L₃, L₈, L₉, L₁₇, and L₂₆; the third example candidate network topology 510 comprises links L₃, L₅, L₉, L₁₅, and L₂₅; and the M−1^{th} example candidate network topology 512 comprises links L₁, L₃, L₁₁, L₁₃ and L₁₄.

Reference is now made to FIG. 6 which illustrates an example method 600 for generating the seed candidate network topology. The seed candidate network topology is the network topology that satisfies the maximum requirement (e.g. highest demand) for each service for all of time periods in the demand matrix 308. The seed candidate network topology is designed to represent the worst-case network topology and by including the seed candidate network topology in the set of candidate network topologies the set of candidate topologies is brought to the optimum network topology faster. More particularly, the seed candidate network topology is used to guide the evolution of the candidate network topologies, thus improving the performance (in terms of computational expense and time) of this highly complex optimization problem. Without using such a seed candidate network topology it can take weeks to determine the optimum network topology using current hardware.

The method 600 begins at block 602 where the maximum requirement (e.g. demand) for each service for all of the time periods or epochs is identified. In some cases identifying the maximum requirement for a particular service for all the time periods or epochs comprises selecting the largest or highest requirement (demand) value in the demand matrix for that service.

The maximum requirements may, optionally, be stored, at block 604, in a demand matrix referred to as the maximum demand matrix.

This is illustrated in FIG. 7, where a demand matrix 702 is analyzed to generate the maximum demand matrix 704. In particular, each row of the demand matrix 702 is analyzed to identify the highest requirement for each service. The highest requirement for a particular service is then stored in the corresponding row of the maximum demand matrix 704. For example, the first service, S₁, has requirements (demands) of 5, 10, 10, and 2 in epochs 1, 2, 3 and N respectively. The largest demand value for the first service, S₁, is then 10 which is stored in the first row of the maximum demand matrix 704. Similarly, the fourth service, S₄, has requirements (demand) of 20, 45, 15 and 2 in epochs 1, 2, 3 and N respectively. The largest demand value for the fourth service, S₄, is 45 which is stored in the fourth row of the maximum demand matrix 704.

Once the worst requirement for each service has been identified and stored in a maximum demand matrix the method 600 proceeds to block 606.

At block 606 the best route for each service through a network comprising all of the possible links of the set of network resources 308 is identified. The best route for a service comprises a set of links that the traffic traverses to get from the start node to the end node. The best route for each service may be determining by a generic routing engine (GRE) through an iterative process. The iterative process may comprise generating a set of candidate service routings, evaluating the candidate service routings to determine how well they satisfy the routing constraints and/or requirements for each service and evolving the set of candidate service routings until a stop condition has been met. Alternatively, the services may be routed using a predefined routing protocol such a Border Gateway Protocol (BGP), Internet Protocol (IP), IP with equal-cost multi-path (ECMP), least cost, or constrained shortest path first (CSPF).

This is illustrated in FIG. 7, where the maximum demand matrix 704 is used by, for example, a generic routing engine to determine a set of best routes 706. The set of best routes 706 comprises the best route for each service as determined by the generic routing engine. Each best route comprises a list of links that the traffic for that service traverses or travels to get from the start node to the end node and may be represented by an array or vector of links. For example, the best route for the first service S₁ comprises link L₁₂, L₁₃ and L₁ which means that traffic travels from Node A to Node B over links L₁₂, L₁₃ and L₁. Similarly, the best route for the fourth service, S₄, comprises links L₁₂, L₁₈, L₁₇ and L₈ which means that traffic travels from Node A to Node E over links L₁₂, L₁₈, L₁₇ and L₈.

Once the best route for each service has been identified the method 600 proceeds to block 608.

At block 608 the seed candidate network topology is generated from the set of best routes. In some cases the seed candidate network topology is generated from the set of best routes to include all of the links that are part of at least one best route. In other words the seed candidate network topology comprises all of the unique links in the set of best routes.

This is illustrated in FIG. 7, where the set of best routes 706 comprises twelve unique links L₁, L₄, L₆, L₈, L₁₀, L₁₂, L₁₃, L₁₄, L₁₅, L₁₆, L₁₇, L₁₈ and so the seed candidate network topology 708 is generated to include these twelve unique links. Although the links are listed in the seed candidate network topology 708 in numerical order, it will be evident to a person of skill in the art that where the link identifiers are used to identify the links, the links may be listed in any order.

Once the seed candidate network topology has been generated the method 600 ends.

Reference is now made to FIG. 8 which illustrates an example method of assigning capacity (e.g. bandwidth) values to the links of a candidate network topology 800. In FIG. 8 the candidate network topology 800 comprises eight nodes 802 (including four edge nodes A, B, C and D) and eight links (L₁-L₈) 804 connecting the nodes. There are three services S₁ 806, S₂ 808 and S₃ 810 running over the network. The first service S₁ 806 sends traffic from node C to node D, the second service S₂ 808 sends traffic from node C to node B, and the third service S₃ 810 sends traffic from node C to node A. The requirement of each service for each of three time periods or epochs is set out in a demand matrix 812.

To allocate capacity (e.g. bandwidth) values to each link 804 of the candidate network topology 800, first the route (the set of links traversed to get from the source node to the destination) for each service is determined using, for example a generic routing engine (GRE) or a known routing protocol as described above.

In the example of FIG. 8, it is determined that the first service S₁ 806 is routed from node C to node D via L₇, L₅ and L₆; the second service S₂ 808 is routed from node C to node B via L₇, L₄, and L₈; and the third service S₃ 810 is routed from node C to node A via L₇, L₅, L₂ and L₁.

Next it is determined, for each link, the amount of traffic that will run over that link in each epoch. In particular, the amount of traffic that will run over a link will be equal to the sum of the requirements for each service that runs over the link. For example, all three services S₁, S₂ and S₃ run over L₇ thus in epoch 1 the amount of traffic run over L₁ is 15 (5+6+4), in epoch 2 it is 22 (10+8+4), and for epoch 3 is 29 (10+15+4).

Next the maximum amount of traffic that will run over each link over all epochs is determined and a capacity (e.g. bandwidth) value greater than or equal to that maximum is assigned to that link. For example, the maximum amount of traffic over L₇ is 29, which occurs in epoch 3, thus a minimum capacity (e.g. bandwidth) value of 29 is assigned to L₇.

In some cases maximum utilization values are assigned to one or more of the links which may be taken into account in assigning capacity (e.g. bandwidth) values to the links. For example, if a particular link is assigned a maximum utilization of 33.33% then a calculated utilization of 10 Gbps would result in a capacity value of at least 30 Gbps being assigned to the link. The maximum utilization values may be set out in the set of network resources 318.

The actual capacity (e.g. bandwidth) values that can be assigned to a particular link may be set out in the set of network resources 318. For example, the set of network resources 318 may specify that the capacity (e.g. bandwidth) on a certain link may only be increased in increments of 10 Gbps.

In some cases the best route for each service is determined for the candidate network topology both in steady state (e.g. all links and nodes are active) and in one or more failure states (e.g. one or more nodes and/or links is deemed inactive). In these cases the amount of traffic over each link in each state is then determined for each epoch. The maximum traffic or utilization for a particular link is the maximum traffic or utilization over all epochs over all states.

Reference is now made to FIG. 9 which illustrates an example set of constraints 310. As described above the constraints outline the metrics or features for evaluating the candidate network topologies. For example, the constraints 310 of FIG. 9 include the following: adjacency limit; minimum cost; shortest path; shortest path with tolerance; delay limit; latency/jitter; optical signal to noise ratio (OSNR); optical distance; service protection; hops; differential delay; and disjointedness.

An adjacency limit constraint specifies that the number of adjacent nodes is to be limited. This limit may be required due to a hardware limit (e.g. maximum number of cards) etc. A minimum cost constraint specifies that the minimum routed cost solution should be selected. A shortest (distance) path constraint specifies that the shortest path route should be selected when routing services. The user may be able to specify an acceptable tolerance limit so that the absolute shortest path route does not always have to be taken, but a route that is within the tolerance of being the shortest path is acceptable. The delay limit constraint specifies the maximum amount of delay between transmission and receipt of service traffic. The latency/jitter constraint specifies that latency or jitter should be minimized.

The OSNR constraint specifies that OSNR should be optimized. The optical distance specifies that the maximum distance for optical links cannot be exceeded (otherwise the optical link will not work or needs to be regenerated incurring additional expense and network complexity). The service protection constraint specifies that there should be a backup route available in case the main route has a failure. This constraint can be specified for all or or only some of the services. The hops protection constraint specifies that the number of hops between start and end nodes should be minimized. The differential delay constraint specifies that the difference in delay between two or more services should be minimized. The disjointedness constraint specifies that there should be no shared links, nodes and/or shared risk groups (SRGs) between one or more disjoint services. SRGs (also known as shared risk link groups (SRGLs)) are things that share a common risk. For example, all routers in a building share the risk that the building is destroyed by a fire, flood or earthquake. Similarly, all the cables in a duct share the same risk of the duct being cut.

The constraints may be classified as being either hard constraints or soft constraints. A hard constraint must be satisfied for the candidate network topology to be a viable solution. Accordingly a candidate network topology that does not satisfy a hard constraint will have a low fitness value. Hard constraints usually specify a particular threshold that has to be met. In the example set of constraints in FIG. 9, the adjacency limit, shortest path limit (without a tolerance), delay limit, optical distance and service protection constraints are hard constraints. All the other constraints are soft constraints.

Each hard constraint may be assigned a penalty value which is used in calculating the fitness value when the constraint is not met. This is used to push the fitness value to a poorer or less favorable value when a candidate network topology does not meet a hard constraint.

It will be evident to a person of skill in the art that the constraints illustrated in FIG. 9 are examples only and any other routing, topology or other type of constraints may be used or specified.

Reference is now made to FIGS. 10 and 11 which illustrate an example method 1000 for evaluating a candidate network topology (including the service routings and capacity values identified by the capacity allocation module 305) 1102 which may be executed by the candidate evaluation module 306. The method 1000 starts at block 1002 where the candidate network topology (including the service routings and capacity values identified by the capacity allocation module 405) 1102 is received at the candidate evaluation module 306. As described above, the candidate network topology 1102 comprises a list of links forming the candidate network topology. For example, the candidate network topology comprises links L₁, L₄, L₆, L₈, L₁₀, L₁₂, L₁₃, L₁₄, L₁₅, L₁₆, L₁₇, L₁₈. Once the candidate network topology (including the service routings and capacity values identified by the capacity allocation module 305) 1102 has been received, the method 1000 proceeds to blocks 1004₁ to 1004_{N} where N is the number of time periods or epochs being evaluated.

At each of blocks 1004₁ to 1004_{N} the candidate evaluation module 306 generates a fitness value 1104₁ to 1104_{N} for the candidate network topology 1102 for one of the time periods or epochs in the demand matrix. Each fitness value 1104₁ to 1104_{N} is a quantitative measure of how well the candidate network topology 1002 meets the constraint(s) 310 and traffic pattern (demands) for that time period or epoch as specified in demand matrix 308. In other words the fitness value 1104 defines how “good” a network topology is and thus can be used to rank candidate network topologies based on how well they meet the demands (as specified by the demand matrix 308) and the constraint(s) 310.

In some cases each fitness value 1104₁ to 1104_{N} is a number between 0 and 1 where 1 indicates the best network topology and 0 indicates a poor network topology (or vice versa). However, it will be evident to a person of skill in the art that this is an example only and that the fitness values 1104₁ to 1104_{N} may be generated to fall in a different range.

In some cases the fitness value 1104₁ to 1104_{N} for a particular time period or epoch may be generated by calculating a sub-fitness value for each constraint; and combining the sub-fitness values (e.g. summing or averaging).

For example, the fitness value 1104₁ to 1104_{N} for a particular time period or epoch (e.g. epoch R) may be calculated using equation (1) shown below:

$$FitnessValue\_EpochR {\_Candidate}_{x} = {\sum }_{w = 1}^{k} ( \frac{{SubFitnessValue}_{w}}{k} ) \qquad ( 1 )$$

where k is the number of constraints

As described above, not all constraints may be of equal importance and so in some cases the fitness value 1104₁ to 1104_{N} for a particular epoch may be calculated from a weighted combination (summing or averaging) of the sub-fitness values (the fitness values for each constraint) where the weights are assigned based on the relative importance of the corresponding constraint. For example, the fitness value may be calculated using equation (2) shown below:

$$FitnessValue\_EpochR {\_Candidate}_{x} = {\sum }_{w = 1}^{k} ( \frac{{SubFitnessValue}_{w} * {Weight}_{w}}{k} ) \qquad ( 2 )$$

where k is the number of constraints, and Weight_{w} is the weight assigned to the w^{th} constraint.

Each sub-fitness value may be generated from a corresponding fitness function that assesses how well the network topology meets the corresponding constraint. Where the constraint is a hard constraint (e.g. a specific upper or lower limit is specified for the constraint) and the candidate network topology 1102 does not meet the constraint, then a penalty may be assessed against the sub-fitness value. For example, the sub fitness value may be adjusted based on the penalty value according to formula (3) shown below:

SubFitnessValue=SubFitnessValue*(Penalty^{Number of Failures}) (3)

where Penalty is a value between 0 and 1 and Number of Failures is the number of times the candidate network topology failed to meet the constraint. For example, if the hard constraint was a maximum number of adjacencies then each time the candidate network topology exceeded the maximum number of adjacencies then the Number of Failures is increased.

Each sub-fitness value (a value indicating the fitness based on a particular constraint) may be calculated in accordance with a fitness function. Accordingly, if the constraints comprise a cost constraint, a utilization constraint, delay constraint, speed constraint, efficiency constraint, and a disjointed constraint then there may be corresponding cost, utilization, delay, speed, efficiency and disjointed fitness functions.

A disjointed fitness function determines whether the routes through the candidate network topology for disjointed services share any links and/or nodes. The disjointed fitness function may be configured so that any sharing of links and/or nodes results in a decrease in the fitness value for the candidate network topology. A cost fitness function may compute the sum of the costs of a route on a network topology and compare this to an expected minimum cost/maximum cost of route from the same source to the same destination.

Once a fitness value 1104₁ to 1104_{N} has been generated for the candidate network topology for each time period or epoch the method 1000 proceeds to block 1006.

At block 1006, the epoch fitness values 1104₁ to 1104_{N} for the candidate network topology are combined (e.g. summed or averaged) to generate a final fitness value 1106 for the candidate network topology. The final fitness value is combination of the overall cost of the topology and bandwidth; and the individual fitness for each epoch based on the routing of individual epoch demands. Once the final fitness value has been generated the method 1000 ends.

Reference is now made to FIG. 12 which illustrates an example method 1200 for evolving the set of candidate network topologies which may be executed by the candidate generation module 302, the capacity allocation module 305, and the candidate evaluation module 306. The objective of the evolving is to increase the quality of the candidate network topologies. The example method 1200 of FIG. 12 comprises identifying one or more parent candidate network topologies in the set of candidate network topologies, generating child candidate network topologies from the parent candidate network topologies, evaluating the child candidate network topologies, adding the child network topologies to the set of candidate network topologies and selecting M candidate network topologies from the combined set. In some cases, the best M candidate network topologies (based on the fitness values) are selected, in other cases M candidate network topologies are selected randomly, and yet other cases the best Z candidate network topologies (based on the fitness values) are selected and M-Z random candidate network topologies are selected.

The method 1200 starts at block 1202 where the candidate generation module 302 obtains the current set of candidate network topologies 304. Once the current set of candidate network topologies 304 has been obtained, the method 1200 proceeds to block 1204.

At block 1204, the candidate generation module 302 selects a predetermined number, in one example 2, of parent candidate network topologies from the set of candidate network topologies 304. The parent candidate network topologies may, for example, be selected based on their associated fitness value (e.g. the best candidate network topologies based on their fitness values may be selected as the parents), they may be randomly selected or they may be selected based on a weighted random method. However, other methods for selecting the parent candidate network topologies may be used. Once the parent candidate network topologies have been selected the method 1200 proceeds to block 1206.

At block 1206, the candidate generation module 302 generates one or more child candidate network topologies from the parent candidate network topologies selected in block 1204.

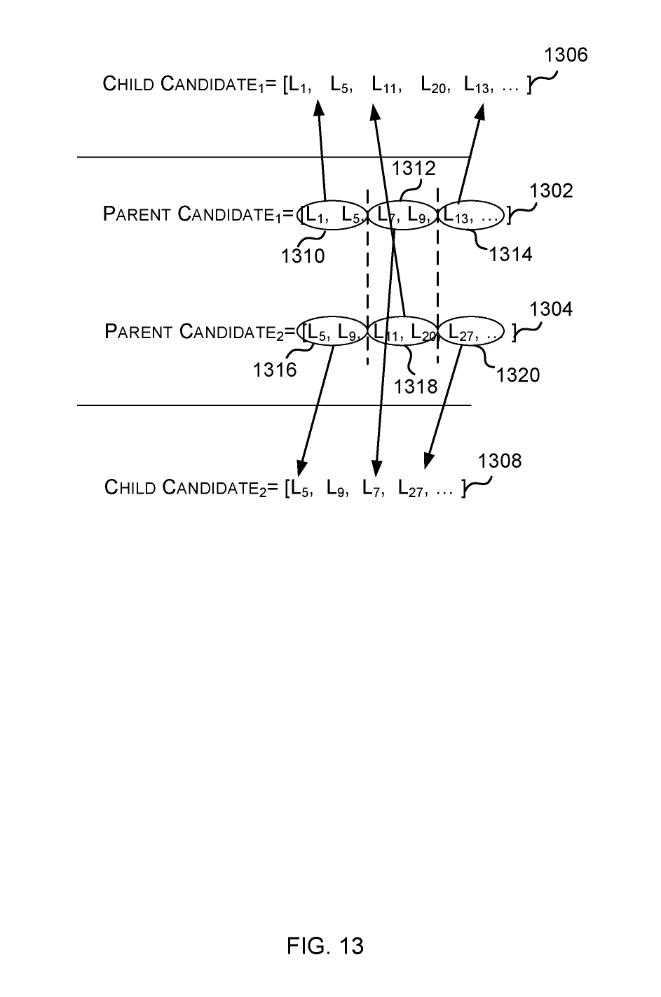

In some cases, the child candidate network topologies are generated from the parent candidate network topologies by mating or combining the parent candidate network topologies using a known technique such as, but not limited to crossover. Mating multiple parent candidate networks may comprise taking portions of each of the parent candidate network topologies and combining them to form a new child candidate network topology. An example of generating child candidate network topologies by mating parent candidate network topologies will be described with reference to FIG. 13.

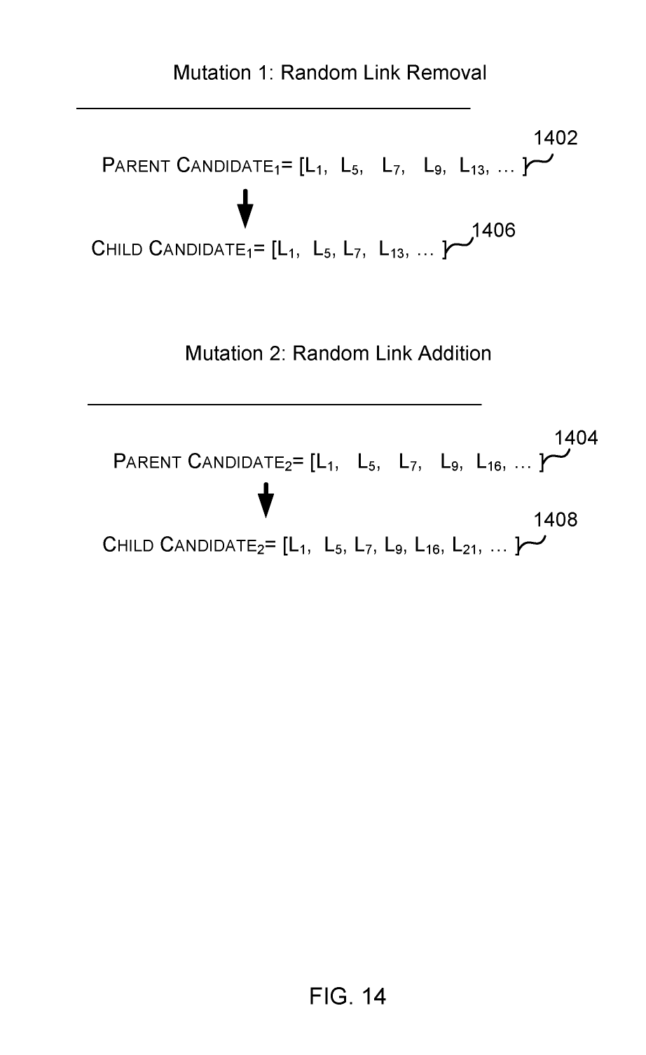

In other cases, the child candidate network topologies are generated by mutating the parent candidate network topologies. As is known to those of skill in the art, mutation involves altering a parent candidate network topology. In some cases this may comprise randomly removing elements (e.g. links) from the parent candidate network topology. In other cases this may comprise randomly adding elements (e.g. links) to the parent candidate network topology. An example of generating child candidate network topologies through mutation will be described with reference to FIG. 14.

In yet other cases, the child candidate network topologies may be generated through both mutation and mating. Once the child candidate network topologies have been generated the method 1200 proceeds to block 1207.

At block 1207, capacity values are assigned to the links of the child network topologies generated at block 1206 in accordance with the methods described above. Once the capacity values have been assigned the method 1200 proceeds to block 1208.

At block 1208, the child candidate network topologies generated at block 1206 are evaluated (e.g. by the candidate evaluation module 306). In some cases evaluation comprises determining a fitness value, as described above, for each child candidate network topology. Once the child candidate network topologies have been evaluated, the method 1200 proceeds to block 1210.

At block 1210, the candidate generation module 302 adds the child candidate network topologies to the set of candidate network topologies. For example, if the set of candidate network topologies obtained in block 1202 comprised fifty candidate network topologies and two child candidate network topologies are generated then the updated set of candidate network topologies will comprise fifty-two candidate network topologies. Once the child candidate network topologies are added to the set of candidate network topologies, the method 1200 proceeds to block 1212.

At block 1212, the candidate generation module 302 removes X candidate network topologies from the combined set of candidate network topologies where X is the number of child candidate network topologies generated at block 1206. The X candidate network topologies may be selected on the basis of being the “worst” candidate network topologies (based on fitness values) or using other criteria, such a random selection criteria

Selecting and removing the “worst” candidate network topologies may comprise ranking the candidate network topologies in the combined set based on their associated fitness value and removing the X candidate network topologies with the worst (e.g. lowest) fitness values. For example, if the set of candidate network topologies obtained in block 1202 comprised fifty candidate network topologies, two child network topologies are generated and added to the set, the two worst (e.g. based on fitness values) are removed from the set to bring the total number of candidate network topologies in the set back to fifty.

If the X candidate network topologies are selected based on random selection, then X random candidate network topologies will be removed from the set. Optionally, the best Z (where Z is less than M) candidate network topologies may be guaranteed to survive (i.e. remain in the set) and the random selection may only be based on the remainder.

Regardless of the selection criteria, by adding X candidates and then removing X candidates the number of candidate network topologies in the set remains constant. Once X candidate network topologies have been removed from the set, the method 1200 ends.

Reference is now made to FIG. 13 which illustrates an example of generating child candidate network topologies by mating or combining parent candidate network topologies. In the example, two parent candidate network topologies 1302 and 1304 are selected from the set of candidate network topologies 304. As described above the parent candidate network topologies may be selected from the set of candidate network topologies based on on certain criteria (e.g. based on their fitness value) or they may be randomly selected from the set of candidate network topologies.

Two child candidate network topologies 1306 and 1308 are then generated by combining aspects (e.g. links) of the two parent candidate network topologies 1302 and 1304 so that the child candidate network topologies 1306 and 1308 comprise a combination of links from both parent candidate network topologies 1302 and 1304. In particular, in the example shown in FIG. 13 each of the two parent candidate network topologies 1302 and 1304 are divided into three parts 1310, 1312, 1314 and 1316, 1318, 1320. The first and third parts 1310 and 1314 of the first parent candidate network topology 1302 are combined with the second part 1318 of the second parent candidate network topology 1304 to form the first child candidate network topology 1306. Then the second part 1312 of the first parent candidate network topology 1302 is combined with the first and third parts 1316 and 1320 of the second parent candidate network topology 1304 to form the second child candidate network topology 1308. This technique is called crossover as different parts of a parent candidate network topology are sent to different child candidate network topologies.

It can be seen that any duplication of links in a child candidate network that result through this process may be removed so that a child candidate network topology does not contain a particular link more than once. For example, both the first part 1316 of the second parent candidate network topology 1304 and the second part 1312 of the first parent candidate network topology 1302 comprise link L₉, but link L₉ is only listed once in the second child candidate network topology 1308.

Although FIG. 13 illustrates generating child candidate network topologies by combining two parent candidate network topologies, it will be evident to a person of skill in the art that the method could be similarly applied to generate child candidate network topologies by combining more than two parent candidate network topologies. Similarly, although FIG. 13 illustrates a two-point crossover, it will be evident to a person of skill in the art that any number of crossover points may be used.

Reference is now made to FIG. 14 which illustrates examples of generating child candidate network topologies by mutating parent candidate network topologies. In the example shown in FIG. 14 two parent candidate network topologies 1402 and 1404 are selected from the set of candidate network topologies 304. As described above, the parent candidate network topologies may be selected from the set of candidate network topologies based on using certain criteria (e.g. based on their fitness value) or they may be randomly selected from the set of candidate network topologies 304.

Two child candidate network topologies 1406 and 1408 are then created from a mutation of one of the parent candidate network topologies 1402 and 1404. As described above, mutation comprises altering the parent candidate network topology in some manner. In the example shown in FIG. 14 the first child candidate network topology 1406 is created from the first parent candidate network topology 1402 through a mutation process that randomly removes one or more links from the parent candidate network topology 1402. For example, the first child candidate network topology 1406 is generated by removing the fourth link (L₉) from the first parent candidate network topology 1402. Other mutation methods may randomly remove more than one link and/or the number of links removed may be randomly selected.

In the example shown in FIG. 14, the second child candidate network topology 1408 is created from the second parent candidate network topology 1404 through a mutation process that randomly adds a link to the parent candidate network topology 1404. For example, the second child candidate network topology 1408 comprises all of the links of the second parent candidate network topology 1404 plus a new link (L₂₁). Other mutation methods may randomly add more than one link and/or the number of links added may be randomly selected.

In other cases links may be both added and removed. For example, mutating may comprise removing a link in the parent candidate network topology 1402 or 1404 to form a child candidate network topology and adding a link to the child candidate network topology that is not already in the child candidate network topology.

It will be evident to a person of skill in the art that FIG. 14 illustrates example mutation techniques and other known mutation techniques may also be used. For example, other mutation techniques may use heuristics to mutate a parent candidate network topology to generate one or more child candidate network topologies.

Reference is now made to FIG. 15 which illustrates an example stop condition which may be used by the stop condition module 312 to determine when to stop the iterative process (e.g. when a sufficiently optimum network topology has been identified). As described above, one stop condition that the stop condition module 312 may use is when the best fitness value for the set of candidate network topologies is sufficiently close to the predicted optimum fitness value. FIG. 15 show a graph 1500 of the best fitness value 1502 over time (e.g. as more iterations are performed).

It can be seen in FIG. 15 that as more iterations are performed the better the best fitness value becomes gradually approaching an asymptote 1504 that represents the optimum or best fitness value. There will be a point in the iterative process where the best fitness value will be within a certain percentage (e.g. 5%) 1506 of the optimum or best fitness value 1504. In some cases the stop condition module 312 is configured to determine a stop condition is satisfied if the best fitness values is within the predetermine percentage (e.g. 5%) 1506 of the optimum fitness value.

In some cases the stop condition module 312 is configured to, after each iteration (e.g. after each evolution step is completed), estimated the asymptote 1504 (e.g. the optimum or best fitness value) and compare the current best fitness value to the calculated asymptote 1504 to determine if the current best fitness value is within the predetermined percentage of the asymptote 1504. The estimation of the asymptote 1504 becomes more accurate over time (as more iterations are performed) as there is more data from which to calculate the asymptote 1504.

In some cases the best fitness as a function of time/iterations 1502 is approximated as a rational function, R. As it known to those of skill in the art a rational function is the ratio of two polynomials. An example rational function, R, is illustrated in equation (4)

$$R = \frac{{A}_{0} + {A}_{1} * X + {A}_{2} * {X}^{2}}{1 + {B}_{1} * X + {B}_{2} * {X}^{2}} \qquad ( 4 )$$

Where the maximum exponent of the two polynomials is equal (e.g. in equation (4) the highest exponent for each of the polynomials is two) then the asymptote 1504 of the curve 1502 (the fitness at infinite iterations) is equal to the ratio of the coefficients of the maximum exponents. This is illustrated in equation (5).

$$Asymptote = \frac{{A}_{2}}{{B}_{2}} = Optimum Best Fitness \qquad ( 5 )$$

The two polynomial coefficients can be computed from a least squares method from the best fitness values after each iteration. Therefore, the more iterations, the more data (e.g. the more best fitness values) there is to estimate the curve and thus the more accurate the coefficients (and thus the more accurate the asymptote).

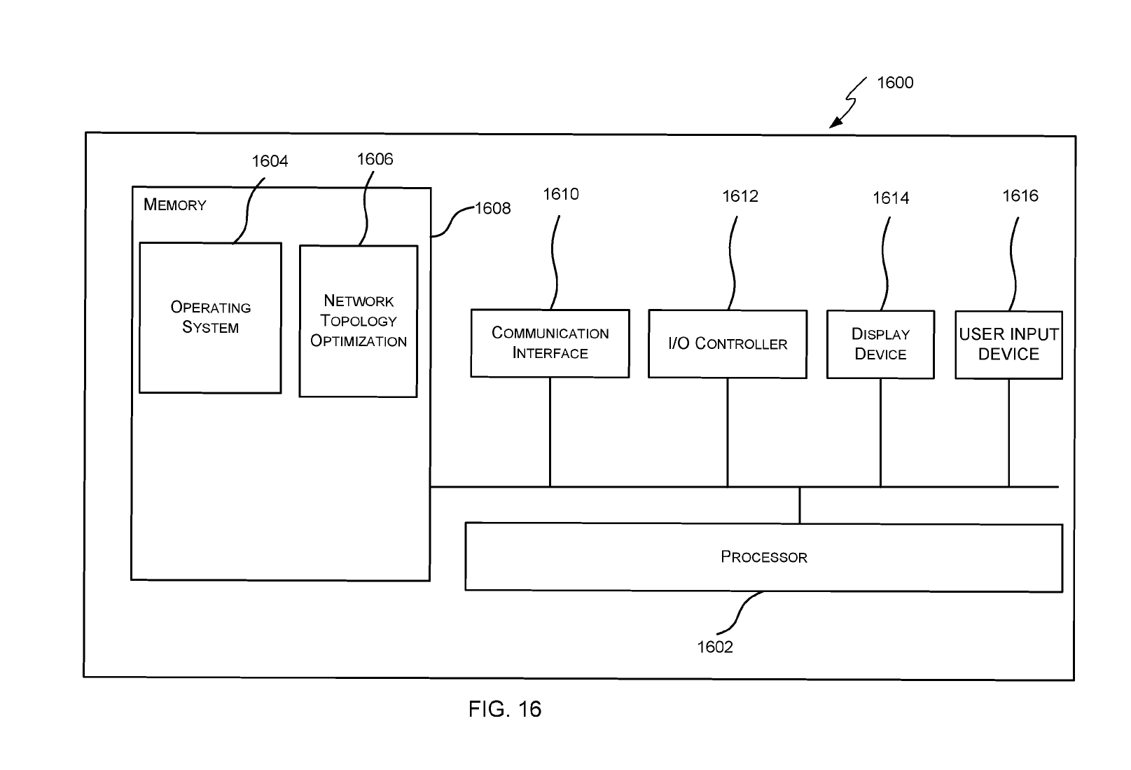

Reference is now made to FIG. 16 which illustrates various components of an exemplary computing-based device 1600 which may be implemented as any form of a computing and/or electronic device, and in which embodiments of the methods and systems described herein may be implemented.

Computing-based device 1600 comprises one or more processors 1602 which may be microprocessors, controllers or any other suitable type of processors for processing computer executable instructions to control the operation of the device in order to identify an optimum network topology for satisfying one or more service requirements based on one or more constraints. In some examples, for example where a system on a chip architecture is used, the processors 1602 may include one or more fixed function blocks (also referred to as accelerators) which implement a part of the method of identifying an optimum network topology in hardware (rather than software or firmware). Platform software comprising an operating system 1604 or any other suitable platform software may be provided at the computing-based device to enable application software 1606, such as network topology optimization software to be executed on the computing based device 1600.

The computer executable instructions may be provided using any computer-readable media that is accessible by computing based device 1600. Computer-readable media may include, for example, computer storage media such as memory 1608 and communications media. Computer storage media (i.e. non-transitory machine readable media), such as memory 1608, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Although the computer storage media (i.e. non-transitory machine readable media, e.g. memory 1608) is shown within the computing-based device 1600 it will be appreciated that the storage may be distributed or located remotely and accessed via a network or other communication link (e.g. using communication interface 1610).

The computing-based device 1600 also comprises an input/output controller 1612 arranged to output display information to a display device 1614 which may be separate from or integral to the computing-based device 1600. The display information may provide a graphical user interface. The input/output controller 1612 is also arranged to receive and process input from one or more devices, such as a user input device 1616 (e.g. a mouse or a keyboard). In an embodiment the display device 1614 may also act as the user input device 1616 if it is a touch sensitive display device. The input/output controller 1612 may also output data to devices other than the display device, e.g. a locally connected printing device (not shown in FIG. 16).

The term ‘processor’ and ‘computer’ are used herein to refer to any device, or portion thereof, with processing capability such that it can execute instructions. The term ‘processor’ may, for example, include central processing units (CPUs), graphics processing units (GPUs or VPUs), physics processing units (PPUs), digital signal processors (DSPs), general purpose processors (e.g. a general purpose GPU), microprocessors, any processing unit which is designed to accelerate tasks outside of a CPU, etc. Those skilled in the art will realize that such processing capabilities are incorporated into many different devices and therefore the term ‘computer’ includes set top boxes, media players, digital radios, PCs, servers, mobile telephones, personal digital assistants and many other devices.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Memories storing machine executable data for use in implementing disclosed aspects can be non-transitory media. Non-transitory media can be volatile or non-volatile. Examples of volatile non-transitory media include semiconductor-based memory, such as SRAM or DRAM. Examples of technologies that can be used to implement non-volatile memory include optical and magnetic memory technologies, flash memory, phase change memory, resistive RAM.

A particular reference to “logic” refers to structure that performs a function or functions. An example of logic includes circuitry that is arranged to perform those function(s). For example, such circuitry may include transistors and/or other hardware elements available in a manufacturing process. Such transistors and/or other elements may be used to form circuitry or structures that implement and/or contain memory, such as registers, flip flops, or latches, logical operators, such as Boolean operations, mathematical operators, such as adders, multipliers, or shifters, and interconnect, by way of example. Such elements may be provided as custom circuits or standard cell libraries, macros, or at other levels of abstraction. Such elements may be interconnected in a specific arrangement. Logic may include circuitry that is fixed function and circuitry can be programmed to perform a function or functions; such programming may be provided from a firmware or software update or control mechanism. Logic identified to perform one function may also include logic that implements a constituent function or sub-process. In an example, hardware logic has circuitry that implements a fixed function operation, or operations, state machine or process.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise an exclusive list and an apparatus may contain additional blocks or elements and a method may contain additional operations or elements. Furthermore, the blocks, elements and operations are themselves not impliedly closed.

The steps of the methods described herein may be carried out in any suitable order, or simultaneously where appropriate. The arrows between boxes in the figures show one example sequence of method steps but are not intended to exclude other sequences or the performance of multiple steps in parallel. Additionally, individual blocks may be deleted from any of the methods without departing from the spirit and scope of the subject matter described herein. Aspects of any of the examples described above may be combined with aspects of any of the other examples described to form further examples without losing the effect sought. Where elements of the figures are shown connected by arrows, it will be appreciated that these arrows show just one example flow of communications (including data and control messages) between elements. The flow between elements may be in either direction or in both directions.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

1. (canceled)

2. A system to determine a topology for a network to support a set of service requirements for each of a plurality of time periods, each set of service requirements specifying a requirement for each of a plurality of services, each requirement indicating an amount of data to be transmitted from a start node to an end node, the system comprising:
a candidate generation module configured to:
generate a set of candidate network topologies from a set of network resources, the set of candidate network topologies comprising a candidate network topology that satisfies each requirement for each service over the plurality of time periods; and
repeatedly evolve the set of candidate network topologies;
a candidate evaluation module configured to repeatedly evaluate each of the candidate network topologies to determine how well the candidate network topology meets the set of service requirements for the plurality of time periods and one or more user-specific technical constraints; and
a stop condition module configured to repeatedly determine if a stop condition is satisfied, and in response to determining the stop condition is satisfied select the best candidate network topology from the set of candidate network topologies based on the evaluation of the candidate network topologies and output the selected candidate network topology.

3. The system of claim 2, wherein evaluating a candidate network topology comprises generating a fitness value for the candidate network topology, the fitness value being a quantitative measure of how well the candidate network topology meets the set of service requirements for the plurality of time periods and one or more constraints.

4. The system of claim 3, wherein generating a fitness value for the candidate network topology comprises generating a time period fitness value for each time period of the plurality of time periods and combining the time period fitness values to generate the fitness value for the candidate network topology.

5. The system of claim 4, wherein generating a time period fitness value for a particular candidate network topology comprises generating a sub-fitness value for each constraint and combining the sub-fitness values to generate the time period fitness value, each sub-fitness value being a quantitative measure of how well the candidate network topology meets the constraint.

6. The system of claim 5, wherein each constraint is assigned a weight and the combination of the sub-fitness values is a weighted combination based on the assigned weights.

7. The system of claim 2, wherein the set of network resources comprises a plurality of links and generating the candidate network topology satisfying each requirement for each service over the plurality of time periods comprises:
identifying the maximum requirement for each service over all the time periods,
determining the best route for each service using the maximum requirements, each route comprising one or more links from the set of network resources; and
configuring the candidate network topology satisfying each requirement for each service over the plurality of time periods to comprise each link forming part of at least one best route.

8. The system of claim 2, wherein the set of network resources comprises a plurality of nodes and a plurality of links, each link connecting two of the plurality of nodes.

9. The system of claim 8, wherein each candidate network topology of the set of candidate network topologies comprises a subset of the nodes and links in the set of network resources.

10. The system of claim 9, wherein each candidate network topology is represented by a vector of the links forming the candidate network topology.

11. The system of claim 2, wherein evolving the set of candidate network topologies comprises generating at least one additional candidate network topology, adding the at least one additional candidate network topology to the set of candidate network topologies, and removing x of the candidate network topologies from the set of candidate network topologies, wherein x is the number of additional candidate network topologies generated.

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. A computer-implemented method to determine a topology for a network to support a set of service requirements for each of a plurality of time periods, each set of service requirements specifying a requirement for each of a plurality of services, each requirement indicating an amount of data to be transmitted from a start node to an end node, the method comprising:
generating a set of candidate network topologies, at a candidate generation module, from a set of network resources, the set of candidate network topologies comprising a candidate network topology that satisfies each requirement for each service over the plurality of time periods;
repeatedly evaluating, at a candidate evaluation module, each of the candidate network topologies to determine how well the candidate network topology meets the set of service requirements for the time periods and one or more user-specified technical constraints;
repeatedly determining, at a stop condition module, if a stop condition is satisfied;
in response to determining the stop condition is not satisfied, evolving the set of candidate network topologies;
in response to determining the stop condition is satisfied, selecting the best candidate network topology from the set of candidate network topologies based on the evaluation of the candidate network topologies; and
outputting the selected candidate network topology.

30. The method of claim 29, wherein evaluating a candidate network topology comprises generating a fitness value for the candidate network topology, the fitness value being a quantitative measure of how well the candidate network topology meets the set of service requirements for the plurality of time periods and the one or more constraints.

31. The method of claim 30, wherein generating a fitness value for the candidate network topology comprises generating a time period fitness value for each time period of the plurality of time periods and combining the time period fitness values to generate the fitness value for the candidate network topology.

32. The method of claim 31, wherein generating a time period fitness value for a particular candidate network topology comprises generating a sub-fitness value for each constraint using the set of requirements for that time period and combining the sub-fitness values to generate the time period fitness value, each sub-fitness value being a quantitative measure of how well the candidate network topology meets the constraint.

33. The method of claim 32, wherein each constraint is assigned a weight and the combination of the sub-fitness values is a weighted combination based on the assigned weights.

34. The method of claim 29, wherein the set of network resources comprises a plurality of links and generating the candidate network topology satisfying each requirement for each service over the plurality of time periods comprises:
identifying the maximum requirement for each service over all the time periods,
determining the best route for each service using the maximum requirements, each route comprising one or more links from the set of network resources; and
configuring the candidate network topology satisfying each requirement for each service over the plurality of time periods to comprise each link forming part of at least one best route.

35. The method of claim 29, wherein the set of network resources comprises a plurality of nodes and a plurality of links, each link connecting two of the plurality of nodes.

36. The method of claim 35, wherein each candidate network topology of the set of candidate network topologies comprises a subset of the nodes and links in the set of network resources.

37. The method of claim 36, wherein each candidate network topology is represented by a vector of the links forming the candidate network topology.

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. A computer readable storage medium having encoded thereon computer readable program code which when run by a computer causes the computer to perform the method of claim 29.
